(19) United States
(12) Patent Application Publication
(10) Pub. No.: US 2003/0031454 A1
(43) Pub. Date: Feb. 13, 2003

(54) Information reception recording/reproducing method and information reception recording/reproducing apparatus

(76) Inventor: Koichi Kameyama, Saijo-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/169,255

(22) PCT Filed: Oct. 31, 2001
(86) PCT No.: PCT/JP01/09544

(30) Foreign Application Priority Data
Oct. 31, 2000 (JP) 2000-333411

(51) Int. Cl. H04N 7/26; H04N 11/02

(52) U.S. Cl. 386/33; 386/111

(57) ABSTRACT

An information receiving/recording/reproduction apparatus according to the present invention includes, as shown in FIG. 1, a compressively uncodable signal detection unit (102) for detecting information that indicates whether an inputted analog video/audio signal can be compressively encoded or not; and a recording/reproduction management unit (104) for managing a recording/reproduction state of the compressively encoded data on the basis of the information that is obtained from the compressively uncodable signal detection unit (102), to manage the recording/reproduction state of the compressively encoded data.

Accordingly, when the data are reproduced, problems such as disturbance of images, and in the worst case, freeze of the system are prevented on the basis of a state of the inputted analog video/audio signal.

### TECHNICAL FIELD

The present invention relates to an information receiving/recording/reproduction method and an information receiving/recording/reproduction apparatus, which receives an analog video/audio signal, converts the analog signal into a digital signal, compressively encodes the digital signal, records the compressively encoded digital data in a randomly accessible recording medium, decompressively decodes the compressively encoded digital data which is read from the recording medium, and converts the digital data into analog data to output an analog video/audio signal.

### BACKGROUND ART

Conventionally, as a method for receiving an analog video/audio signal, converting the analog signal into a digital signal, compressively encoding the digital signal, recording the compressively encoded digital data (hereinafter, referred to as “compressively encoded data”) in a randomly accessible recording medium, decompressively decoding the compressively encoded data that is read from the recording medium, and converting the digital data into analog data to output an analog video/audio signal, and an apparatus for the method, a television program recording/reproduction apparatus is described in Japanese Published Patent Application No. 2000-92446.

Hereinafter, the prior art information receiving/recording/reproduction apparatus will be described with reference to FIG. 22.

FIG. 22 is a diagram illustrating a structure of the prior art information receiving/recording/reproduction apparatus.

In FIG. 22, the prior art information receiving/recording/reproduction apparatus includes a receiving circuit 1801 for receiving a video signal of a television program; an A/D conversion circuit 1802 for converting an analog signal into a digital signal; a data compression circuit 1803 for compressing the digitally-converted video signal according to MPEG processing or the like; a hard disk 1805 as a randomly accessible recording medium, a hard disk controller 1804 for recording the compressively encoded data in the hard disk 1805 or reading the data from the hard disk 1805; a data decompression circuit 1806 for decompressing the compressively encoded data into a digital signal; a D/A conversion circuit 1807 for converting the digital signal into an analog signal; and an output terminal 1808 for outputting the analog signal to a monitor or the like.

The conventional apparatus having the above-mentioned configuration converts an analog video signal of a television program received by the receiving circuit 1801 into a digital signal in the A/D conversion circuit 1802, compresses the digital signal in the data compression circuit 1803, records the compressed data in the hard disk 1805 by using the hard disk controller 1804, reads the compressed video data that is recorded in the hard disk 1805 using the hard disk controller 1804, decompresses the compressed video data in the data decompression circuit 1807, converts the digital video data into an analog video signal in the D/A conversion circuit 1807, and outputs the signal to be displayed.

In this conventional information receiving/recording/reproduction apparatus, when a horizontal sync signal or a vertical sync signal of the inputted analog video signal is abnormal, i.e., for example in the case where the inputted analog video signal is a noise signal in the television signal whose image is seen like sandstorm, such analog video signal cannot be compressively encoded by the data compression circuit 1803. Thus, the recording of the compressively encoded data into the hard disk 1805 is paused, and the recording of the compressively encoded data into the hard disk 1805 is started again at a time when the data turns into a state where it can be compressively encoded by the data compression circuit 1803.

However, when the recording of the compressively encoded data is interrupted and resumed when the data turns into a state where it can be encoded, the structure of the compressively encoded data that is recorded in the hard disk 1805 is broken at a point where the recording is interrupted or where the recording is resumed. Thus, when the compressively encoded data in the hard disk 1805 is decompressively decoded by the data decompression circuit 1806 to be reproduced, image disturbances occur at the points where the recording is interrupted and where the recording is resumed, and, in the worst case, the system may freeze.

The present invention is made to solve the aforementioned problems, and has for its object to provide an information receiving/recording/reproduction method and an information receiving/recording/reproduction apparatus, which are so stable that no image disturbances occur or the system does not freeze in any states of inputted analog video/audio signals.

### DISCLOSURE OF THE INVENTION

An information receiving/recording/reproduction apparatus according to claim 1 of the present invention includes an A/D conversion means for converting an inputted analog video/audio signal into digital data; a compressively encoding means for compressively encoding the digital data; a recording/reproduction management means for managing a state where the compressively encoded digital data are recorded or reproduced in or from a first recording medium that is randomly accessible; a decompressively decoding means for decompressively decoding the compressively encoded digital data; and a D/A conversion means for converting the digital data into an analog video signal, in which a compressively uncodable signal detection means is further included for detecting information indicating whether the inputted analog video/audio signal can be compressively encoded or not, and the recording/reproduction management means manages the state where the compressively encoded digital data are recorded or reproduced into or from the first recording medium in accordance with the information that is obtained by the compressively uncodable signal detection means.

Therefore, the information indicating whether the inputted analog video/audio signal can be compressively encoded or not can be obtained, and the compressively encoded data can be managed on the basis of the obtained information when the compressively encoded data is to be recorded in the recording medium.

According to claim 2 of the present invention, in the information receiving/recording/reproduction apparatus of claim 1, the compressively encoding means or the decompressively decoding means compressively encodes or decompressively decodes the data according to MPEG (Moving Picture Experts Group) standards.

Therefore, the inputted analog video/audio signal can be compressively encoded or decompressively decoded according to MPEG standards.

According to claim 3 of the present invention, in the information receiving/recording/reproduction apparatus of claim 1, the compressively uncodable signal detection means: detects the number of data corresponding to horizontal one line and the number of lines corresponding to vertical one field, of the digital video data that is obtained by the A/D conversion means; compares the detected number of data with a prescribed number of data per line corresponding to the analog video/audio signal, and the detected number of lines with a prescribed number of lines per field corresponding to the analog video/audio signal; and outputs information whether the inputted analog video/audio signal can be compressively encoded or not on the basis of obtained comparison results.

Therefore, the information indicating whether the inputted analog video/audio signal can be compressively encoded or not can be detected.

According to claim 4 of the present invention, in the information receiving/recording/reproduction apparatus of claim 1, the compressively uncodable signal detection means receives information indicating whether a state of compressively encoding for the digital data in the compressively encoding means is successful or unsuccessful, and outputs the information indicating whether the inputted analog video/audio signal can be compressively encoded or not in accordance with the received information.

Therefore, the information indicating whether the inputted analog video/audio signal can be compressively encoded or not can be detected.

According to claim 5 of the present invention, in the information receiving/recording/reproduction apparatus of claim 1, the compressively uncodable signal detection means detects a horizontal sync signal in the inputted analog video/audio signal, decides whether the horizontal sync signal is detected at given time intervals, and outputs the information indicating whether the inputted analog video/audio signal can be compressively encoded or not, on the basis of an obtained result of the decision.

Therefore, the information indicating whether the inputted analog video/audio signal can be compressively encoded or not can be detected.

According to claim 6 of the present invention, in the information receiving/recording/reproduction apparatus of any of claims 1, 4 and 5, the recording/reproduction management means further includes a data management means for managing the compressively encoded digital data to ensure a decompressively decodable data structure in the first recording medium.

Therefore, when the compressively encoded data is recorded in the recording medium, the structure of the compressively encoded data can be prevented from being broken at the interrupt and resumption points of the recording in the recording medium.

According to claim 7 of the present invention, in the information receiving/recording/reproduction apparatus of claim 6, the data management means records the compressively encoded digital data in the first recording medium, with ensuring a data structure in units of one picture.

Therefore, when the compressively encoded data is recorded in the recording medium, the structure of the compressively encoded data can be prevented from being broken at the interrupt and resumption points of the recording in the recording medium.

According to claim 8 of the present invention, in the information receiving/recording/reproduction apparatus of claim 6, the data management means records the compressively encoded digital data in the first recording medium, with ensuring a data structure in units of one GOP (Group of Picture) according to a format based on MPEG standards.

Therefore, when the compressively encoded data is recorded in the recording medium, the structure of the compressively encoded data can be prevented from being broken at the interrupt and resumption points of the recording in the recording medium.

According to claim 9 of the present invention, in the information receiving/recording/reproduction apparatus of claim 7, when it is informed that the inputted analog video/audio signal cannot be compressively encoded while the compressively encoded digital data is being recorded in the first recording medium, the data management means deletes data up to a boundary part of one picture which has already recorded in the first recording medium, to ensure the data structure in units of one picture.

Therefore, when the compressively encoded data is recorded in the first recording medium, the data structure in unit of one picture is ensured, and the structure of the compressively encoded data can be prevented from being broken at the interrupt and resumption points of the recording in the first recording medium.

According to claim 10 of the present invention, in the information receiving/recording/reproduction apparatus of claim 8, when it is informed that the inputted analog video/audio signal cannot be compressively encoded while the compressively encoded digital data is being recorded in the first recording medium, the data management means deletes data up to a boundary part of one GOP that has been already recorded in the first recording medium, to ensure the data structure in units of one GOP.

Therefore, when the compressively encoded data is recorded in the first recording medium, the data structure in unit of one GOP is ensured, and the structure of the compressively encoded data can be prevented from being broken at the interrupt and resumption points of the recording in the first recording medium.

According to claim 11 of the present invention, in the information receiving/recording/reproduction apparatus of any of claims 1, 4 and 5, a second recording medium which is randomly accessible at a speed higher than that of the first recording medium is further included, and the recording/reproduction management means further includes a data management means for temporarily storing the compressively encoded digital data in the second recording medium, and thereafter recording the data that is stored in the second recording medium into the first recording medium.

Therefore, only compressively encoded data securely having a decompressively decodable data structure can be recorded in the first recording medium, and the data structure of the compressively encoded data can be prevented from being broken at the interrupt and resumption points of the recording in the first recording medium when the compressively encoded data is recorded in the first recording medium.

According to claim 12 of the present invention, in the information receiving/recording/reproduction apparatus of claim 11, the data management means records the compressively encoded digital data in the second recording medium with ensuring a data structure in units of one picture, and records the data which securely has the data structure in units of one picture in the second recording medium, into the first recording medium.

Therefore, when the compressively encoded data is recorded in the first recording medium, the structure of the compressively encoded data can be further prevented from being broken at the interrupt and resumption points of the recording in the first recording medium.

According to claim 13 of the present invention, in the information receiving/recording/reproduction apparatus of claim 11, the data management means records the compressively encoded digital data in the second recording medium with ensuring a data structure in units of one GOP according to a format based on MPEG standards, and records the data which securely has the data structure in units of one GOP in the second recording medium, into the first recording medium.

Therefore, when the compressively encoded data is recorded in the first recording medium, the structure of the compressively encoded data can be further prevented from being broken at the interrupt and resumption points of the recording in the first recording medium.

According to claim 14 of the present invention, in the information receiving/recording/reproduction apparatus of claim 12, when it is informed that the inputted analog video/audio signal cannot be compressively encoded while the compressively encoded digital data is being recorded in the second recording medium, the data management means deletes data up to a boundary part of one picture that has already been recorded in the second recording medium, to ensure the data structure in units of one picture.

Therefore, only compressively encoded data which securely has the data structure in unit of one picture can be recorded in the first recording medium.

According to claim 15 of the present invention, in the information receiving/recording/reproduction apparatus of claim 13, when it is informed that the inputted analog video/audio signal cannot be compressively encoded while the compressively encoded digital data is being recorded in the second recording medium, the data management means deletes data up to a boundary part of one GOP that has already been recorded in the second recording medium, to ensure the data structure in units of one GOP.

Therefore, only compressively encoded data which securely has the data structure in unit of one GOP can be recorded in the first recording medium.

According to claim 16 of the present invention, in the information receiving/recording/reproduction apparatus of claim 1, a compressive encoding digital data output means is further included for always outputting digital data that can be compressively encoded, and the compressively encoding digital data output means: outputs the digital data that is obtained by converting the inputted analog video/audio signal into a digital format when it is informed by the compressively uncodable signal detection means that the inputted analog video/audio signal can be compressively encoded; and outputs digital data that is retained in the information receiving/recording/reproduction apparatus when it is informed by the compressively uncodable signal detection means that the inputted analog video/audio signal cannot be compressively encoded.

Therefore, even when the inputted analog video/audio signal cannot be compressively encoded, compressively encodable digital data can be always outputted.

According to claim 17 of the present invention, in the information receiving/recording/reproduction apparatus of claim 16, the digital data which are retained in the information receiving/recording/reproduction apparatus and outputted by the compressive encoding digital data output means are data which constitute single-color image data.

Therefore, the user can know whether the inputted analog video/audio signal can be compressively encoded or not by checking data that is recorded in the recording medium.

According to claim 18 of the present invention, in the information receiving/recording/reproduction apparatus of claim 16, the digital data which are retained in the information receiving/recording/reproduction apparatus and outputted by the compressive encoding digital data output means are data which constitute image data including message information.

Therefore, when data recorded in the recording medium is reproduced, whether an analog video/audio signal can be compressively encoded or not can be displayed visually, whereby the user can know whether the analog video/audio signal can be compressively encoded or not.

According to claim 19 of the present invention, in the information receiving/recording/reproduction apparatus of claim 1, the recording/reproduction management means further includes: an input data information recording means for recording compressively encoded digital data in the first recording medium in arbitrary units, and adding the information that is obtained from the compressively uncodable signal detection means to the compressively encoded digital data that has been recorded in the first recording medium in the arbitrary units to record the same, and this information receiving/recording/reproduction apparatus further includes: a decompressive decoding digital data output means for selecting data that is to be outputted to the decompressively decoding means among the compressively encoded digital data that is read from the first recording medium, in accordance with the information that has been recorded in the first recording medium by the input data information recording means, and outputting the selected data.

Therefore, when the data recorded in the recording medium are reproduced, disturbance of images or freeze of the system which may occur depending on the states of data can be avoided.

According to claim 20 of the present invention, in the information receiving/recording/reproduction apparatus of claim 19, the decompressive decoding digital data output means: detects the information that has been recorded by the input data information recording means, from the data read from the first recording medium; decompressively decodes the readout data when the detected information indicates that the inputted analog video/audio signal can be compressively encoded; and abandons the readout data when the detected information indicates that the inputted analog video/audio signal cannot be compressively encoded.

Therefore, among the data recorded in the recording medium, data which may cause disturbance of images or freeze of the system can be prevented from being reproduced.

According to claim 21 of the present invention, in the information receiving/recording/reproduction apparatus of claim 19, the recording/reproduction management means records the compressively encoded digital data in the first recording medium in units of one picture.

Therefore, when the compressively encoded data is recorded in the recording medium, the data is recorded in units of one picture, and the structure of the compressively encoded data can be prevented from being broken at the interrupt and resumption points of the recording in the recording medium.

According to claim 22 of the present invention, in the information receiving/recording/reproduction apparatus of claim 19, the recording/reproduction management means records the compressively encoded digital data in the first recording medium in units of one GOP according to a format based on MPEG standards.

Therefore, when the compressively encoded data is recorded in the recording medium, the data is recorded in units of one GOP, and the structure of the compressively encoded data can be prevented from being broken at the interrupt and resumption points of the recording in the recording medium.

According to claim 23 of the present invention, there is provided an information receiving/recording/reproduction method for converting an inputted analog video/audio signal into digital data, compressively encoding the digital data, recording the compressively encoded digital data in a first recording medium that is randomly accessible, decompressively decoding the compressively encoded digital data that is read from the first recording medium, converting the digital data into an analog video signal, and outputting the analog video signal, comprising: a compressively uncodable signal detection step of detecting information indicating whether the inputted analog video/audio signal can be compressively encoded or not; and a recording/reproduction management step of managing a state where the compressively encoded digital data are recorded or reproduced, in accordance with the information that is obtained in the compressively uncodable signal detection step.

Therefore, the information indicating whether the inputted analog video/audio signal can be compressively encoded or not can be obtained, and the state of the compressively encoded data can be managed on the basis of the obtained information when the compressively encoded data is to be recorded in the recording medium.

According to claim 24 of the present invention, in the, information receiving/recording/reproduction method of claim 23, the digital data is compressively encoded or decompressively decoded according to MPEG (Moving Picture Experts Group) standards.

Therefore, the inputted analog video/audio signal can be compressively encoded or decompressively decoded according to MPEG standards.

According to claim 25 of the present invention, in the information receiving/recording/reproduction method of claim 23, in the compressively uncodable signal detection step, when the inputted analog video/audio signal is converted into digital data, the number of data corresponding to horizontal one line and the number of lines corresponding to a vertical one field, of the obtained digital video data are detected; the detected number of data is compared with a prescribed number of data per line corresponding to the analog video/audio signal, and the detected number of lines is compared with a prescribed number of lines per field corresponding to the analog video/audio signal; and information indicating whether the inputted analog video/audio signal can be compressively encoded or not is outputted on the basis of obtained comparison results.

Therefore, the information indicating whether the inputted analog video/audio signal can be compressively encoded or not can be detected.

According to claim 26 of the present invention, in the information receiving/recording/reproduction method of claim 23, in the compressively uncodable signal detection step, when the digital data is compressively encoded, information indicating whether a state of the compressive encoding is successful or unsuccessful is received, and information indicating whether the inputted analog video/audio signal can be compressively encoded or not is outputted in accordance with the received information.

Therefore, the information indicating whether the inputted analog video/audio signal can be compressively encoded or not can be detected.

According to claim 27 of the present invention, in the information receiving/recording/reproduction method of claim 23, in the compressively uncodable signal detection step, a horizontal sync signal in the inputted analog video/audio signal is detected, it is decided whether the horizontal sync signal is detected at given time intervals, and information indicating whether the inputted analog video/audio signal can be compressively encoded or not is outputted on the basis of an obtained result of the decision.

Therefore, the information indicating whether the inputted analog video/audio signal can be compressively encoded or not can be detected.

According to claim 28 of the present invention, in the information receiving/recording/reproduction method of any of claims 23, 26 and 27, the recording/reproduction management step further includes a data management step of managing the compressively encoded digital data that is recorded in the first recording medium to ensure a decompressively decodable data structure.

Therefore, when the compressively encoded data is recorded in the recording medium, the structure of the compressively encoded data can be prevented from being broken at the interrupt and resumption points of the recording in the recording medium.

According to claim 29 of the present invention, in the information receiving/recording/reproduction method of claim 28, in the data management step, the compressively encoded digital data is recorded in the first recording medium, with ensuring a data structure in units of one picture.

Therefore, when the compressively encoded data is recorded in the recording medium, the structure of the compressively encoded data can be prevented from being broken at the interrupt and resumption points of the recording in the recording medium.

According to claim 30 of the present invention, in the information receiving/recording/reproduction method of claim 28, in the data management step, the compressively encoded digital data is recorded in the first recording medium, with ensuring a data structure in units of one GOP (Group of Picture) according to a format based on MPEG standards.

Therefore, when the compressively encoded data is recorded in the recording medium, the structure of the compressively encoded data can be prevented from being broken at the interrupt and resumption points of the recording in the recording medium.

According to claim 31 of the present invention, in the information receiving/recording/reproduction method of claim 29, in the data management step, when it is informed that the inputted analog video/audio signal cannot be compressively encoded while the compressively encoded digital data is being recorded in the first recording medium, data are deleted up to a boundary part of one picture which has been already recorded in the first recording medium, to ensure the data structure in units of one picture.

Therefore, when the compressively encoded data is recorded in the first recording medium, the data structure in unit of one picture can be ensured, and the structure of the compressively encoded data can be prevented from being broken at the interrupt and resumption points of the recording in the first recording medium.

According to claim 32 of the present invention, in the information receiving/recording/reproduction method of claim 30, in the data management step, when it is informed that the inputted analog video/audio signal cannot be compressively encoded while the compressively encoded digital data is being recorded in the first recording medium, data are deleted up to a boundary part of one GOP which has already been recorded in the first recording medium, to ensure the data structure in units of one GOP.

Therefore, when the compressively encoded data is recorded in the first recording medium, the data structure in unit of one GOP can be ensured, and the structure of the compressively encoded data can be prevented from being broken at the interrupt and resumption points of the recording in the first recording medium.

According to claim 33 of the present invention, in the information receiving/recording/reproduction method of any of claims 23, 26 and 27, a second recording medium which is randomly accessible at a speed higher than that of the first recording medium is further included, and the recording/reproduction management step further includes a data management step of temporarily storing the compressively encoded digital data in the second recording medium, and thereafter recording the data stored in the second recording medium into the first recording medium.

Therefore, only compressively encoded data which securely has a decompressively decodable data structure can be recorded in the first recording medium, and the data structure of the compressively encoded data can be prevented from being broken at the interrupt and resumption points of the recording in the first recording medium when the compressively encoded data is recorded in the first recording medium.

According to claim 34 of the present invention, in the information receiving/recording/reproduction method of claim 33, in the data management step, the compressively encoded digital data is recorded in the second recording medium with ensuring a data structure in unit of one picture, and the data which securely has the data structure in unit of one picture in the second recording medium is recorded in the first recording medium.

Therefore, when the compressively encoded data is recorded in the first recording medium, the structure of the compressively encoded data can be further prevented from being broken at the interrupt and resumption points of the recording in the first recording medium.

According to claim 35 of the present invention, in the information receiving/recording/reproduction method of claim 33, in the data management step, the compressively encoded digital data is recorded in the second recording medium with ensuring a data structure in unit of one GOP according to a format based on MPEG standards, and the data which securely has the data structure in unit of one GOP in the second recording medium is recorded in the first recording medium.

Therefore, when the compressively encoded data is recorded in the first recording medium, the structure of the compressively encoded data can be further prevented from being broken at the interrupt and resumption points of the recording in the first recording medium.

According to claim 36 of the present invention, in the information receiving/recording/reproduction method of claim 34, in the data management step, when it is informed that the inputted analog video/audio signal cannot be compressively encoded while the compressively encoded digital data is being recorded in the second recording medium, data are deleted up to a boundary part of one picture that has already been recorded in the second recording medium, to ensure the data structure in unit of one picture.

Therefore, only compressively encoded data which securely has the data structure in unit of one picture can be recorded in the first recording medium.

According to claim 37 of the present invention, in the information receiving/recording/reproduction method of claim 35, in the data management step, when it is informed that the inputted analog video/audio signal cannot be compressively encoded while the compressively encoded digital data is being recorded in the second recording medium, data are deleted up to a boundary part of one GOP which has already been recorded in the second recording medium, to ensure the data structure in unit of one GOP.

Therefore, only compressively encoded data which securely has the data structure in unit of one GOP can be recorded in the first recording medium.

According to claim 38 of the present invention, in the information receiving/recording/reproduction method of claim 23, a compressively encoding digital data output step of always outputting digital data that can be compressively encoded is further included, and in the compressively encoding digital data output step, digital data that is obtained by converting the inputted analog video/audio signal into a digital format is outputted when it is informed that the inputted analog video/audio signal can be compressively encoded, and digital data that is retained in an information receiving/recording/reproduction apparatus is outputted when it is informed that the inputted analog video/audio signal cannot be compressively encoded.

Therefore, even when the inputted analog video/audio signal cannot be compressively encoded, compressively encodable digital data can be always outputted.

According to claim 39 of the present invention, in the information receiving/recording/reproduction method of claim 38, the digital data which are retained in the information receiving/recording/reproduction apparatus and outputted in the compressively encoding digital data output step are data which constitute single-color image data.

Therefore, the user can know whether the inputted analog video/audio signal can be compressively encoded or not by checking data that is recorded in the recording medium.

According to claim 40 of the present invention, in the information receiving/recording/reproduction method of claim 38, the digital data which are retained in the information receiving/recording/reproduction apparatus and outputted in the compressively encoding digital data output step are data which constitute image data including message information.

Therefore, when data recorded in the recording medium is reproduced, whether the inputted analog video/audio signal can be compressively encoded or not can be displayed visually, whereby the user can know whether the analog video/audio signal can be compressively encoded or not.

According to claim 41 of the present invention, in the information receiving/recording/reproduction method of claim 23, the recording/reproduction management step further includes: an inputted data information recording step of recording compressively encoded digital data in the first recording medium in arbitrary units, and adding the information that is obtained in the compressively uncodable signal detection step to the compressively encoded digital data that has been recorded in the first recording medium in the arbitrary units to record the same, and this information receiving/recording/reproduction method further includes: a decompressive decoding digital data output step of selecting data that is to be decompressively decoded among the compressively encoded digital data that is read from the first recording medium, in accordance with the information that has been recorded in the first recording medium in the input data information recording step, and outputting the selected data.

Therefore, when the data recorded in the recording medium are reproduced, disturbance of images or freeze of the system which may occur depending on the states of data can be avoided.

According to claim 42 of the present invention, in the information receiving/recording/reproduction method of claim 41, in the decompressive decoding digital data output step, the information that has been recorded in the input data information recording step is detected from the data read from the first recording medium, the readout data is decompressively decoded when information indicating that the inputted analog video/audio signal can be compressively encoded is detected, and the readout data is abandoned when information indicating that the inputted analog video/audio signal cannot be compressively encoded is detected.

Therefore, among the data recorded in the recording medium, data which may cause disturbance of images or freeze of the system can be prevented from being reproduced.

According to claim 43 of the present invention, in the information receiving/recording/reproduction method of claim 41, in the recording/reproduction management step, compressively encoded digital data is recorded in the first recording medium in unit of one picture.

Therefore, when the compressively encoded data is recorded in the recording medium, the data is recorded in units of one picture, and the structure of the compressively encoded data can be prevented from being broken at the interrupt and resumption points of the recording in the recording medium.

According to claim 44 of the present invention, in the information receiving/recording/reproduction method of claim 41, in the recording/reproduction management step, compressively encoded digital data is recorded in the first recording medium in unit of one GOP according to a format based on MPEG standard.

Therefore, when the compressively encoded data is recorded in the recording medium, the data is recorded in units of one GOP, and the structure of the compressively encoded data can be prevented from being broken at the interrupt and resumption points of the recording in the recording medium.

### BRIEF DESCRIPTION OF THE DRAWINGS

FIG. 1 is a block diagram illustrating a structure of an information receiving/recording/reproduction apparatus according to a first or second embodiment of the present invention.

FIG. 2 is a flowchart for explaining processes of a compressively uncodable signal detection unit according to the first embodiment for outputting information that indicates whether an inputted analog video/audio signal can be compressively encoded or not.

FIG. 3 is a diagram showing information standard values according to standardization ITU-R BT.601-5 associated with a typical video signal according to the first embodiment.

FIG. 4 is a flowchart for explaining processes when the information that indicates whether an inputted analog video/audio signal can be compressively encoded or not is given to a compressively encoding unit according to the first embodiment.

FIG. 5 is a flowchart for explaining processes when the information that indicates whether an inputted analog video/audio signal can be compressively encoded or not is given to a recording/reproduction management unit according to the first embodiment.

FIG. 6 is a block diagram illustrating a structure of an information receiving/recording/reproduction apparatus according to a first variation of the first embodiment.

FIG. 7 is a flowchart for explaining processes of a compressively uncodable signal detection unit according to the first variation of the first embodiment for outputting information that indicates whether an inputted analog video/audio signal can be compressively encoded or not.

FIG. 8 is a diagram illustrating a structure of an information receiving/recording/reproduction apparatus according to a second variation of the first embodiment.

FIG. 9 is a flowchart for explaining processes of a compressively uncodable detection unit according to the second variation of the first embodiment for outputting information that indicates whether an inputted analog video/audio signal can be compressively encoded or not.

FIG. 10 is a diagram showing specifications of a video signal (standardization RS-170A which are standards and specifications of a television signal published by EIA (Electronic Industries Association) in U.S.)

FIG. 11 is a diagram showing specification values of a video signal according to the NTSC format

FIG. 12 is a diagram illustrating a structure of compressively encoded data which are recorded in a recording medium according to the second embodiment while ensuring the data structure in units of one picture.

FIG. 13 is a flowchart for explaining processes of a recording/reproduction unit according to the second embodiment for recording data in a recording medium while ensuring the data, structure in units of one picture.

FIG. 14 is a diagram illustrating a structure of compressively encoded data which is recorded in the recording medium according to the second embodiment while ensuring the data structure in units of one GOP.

FIG. 15 is a flowchart for explaining processes of the recording/reproduction unit according to the second embodiment for recording data in a recording medium while ensuring the data structure in units of one GOP.

FIG. 16 is a block diagram illustrating a structure of an information receiving/recording/reproduction apparatus according to a third embodiment of the present invention.

FIG. 17 is a flowchart for explaining processes when information that indicates whether an inputted analog video/audio signal can be compressively encoded or not is given to a recording/reproduction management unit according to a third embodiment of the present invention.

FIG. 18 is a block diagram illustrating a structure of an information receiving/recording/reproduction apparatus according to a fourth embodiment of the present invention.

FIG. 19 is a flowchart for explaining processes when information that indicates whether an inputted analog video/audio signal can be compressively encoded or not is given to a recording/reproduction management unit according to the fourth embodiment.

FIG. 20 is a block diagram illustrating a structure of an information receiving/recording/reproduction apparatus according to a fifth embodiment of the present invention.

FIG. 21 is a flowchart for explaining processes of a recording/reproduction management unit according to the fifth embodiment when compressively encoded data is reproduced.

FIG. 22 is a block diagram illustrating a structure of a conventional information receiving/recording/reproduction apparatus.

### BEST MODE FOR CARRYING OUT THE INVENTION

Embodiment 1.

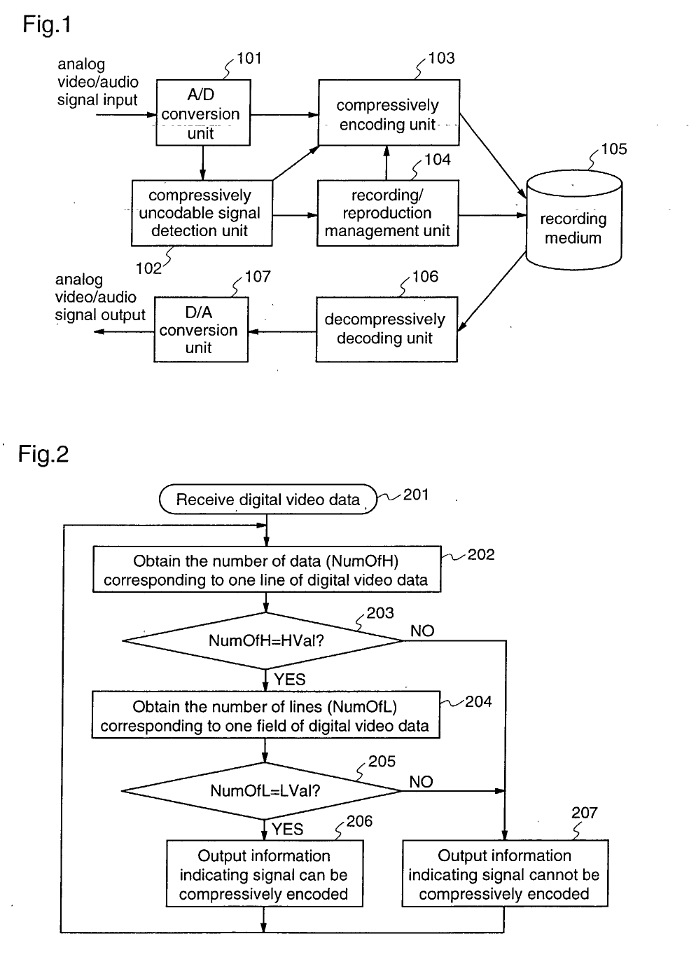

Hereinafter, a first embodiment of the present invention will be described with reference to FIGS. 1 to 7.

An information receiving/recording/reproduction apparatus according to the first embodiment includes a compressively uncodable signal detection unit for detecting whether an inputted analog video/audio signal can be compressively encoded or not; and a recording/reproduction management unit for managing inputting or outputting of compressively encoded data corresponding to the analog video/audio signal, into or from a recording medium, whereby a recording/reproduction state of the compressively encoded data that is recorded in the recording medium is managed by the recording/reproduction management unit on the basis of the information obtained from the compressively uncodable signal detection means.

Initially, the structure of the information receiving/recording/reproduction apparatus according to the first embodiment will be described with reference to FIG. 1.

FIG. 1 is a block diagram illustrating the structure of the information receiving/recording/reproduction apparatus according to the first embodiment.

In this figure, the information receiving/recording/reproduction apparatus according to the first embodiment comprises an A/D conversion unit 101, a compressively uncodable signal detection unit 102, a compressively encoding unit 103, a recording/reproduction management unit 104, a recording medium 105, a decompressively decoding unit 106, and D/A conversion unit 107.

The A/D conversion unit 101 converts an inputted analog video/audio signal into digital data. The compressively uncodable signal detection unit 102 checks horizontal components and vertical components of the digital video data that is outputted from the A/D conversion unit 101, and outputs information that indicates whether the inputted analog video/audio signal can be compressively encoded or not.

The compressively encoding unit 103 carries out a process for compressively encoding the digital data and an output management process for the compressively encoded data, in accordance with the information indicating whether the signal can be compressively encoded or not, which is given from the compressively uncodable signal detection unit 102. The recording/reproduction management unit 104 manages recording of the compressively encoded data that is outputted from the compressively encoding unit 103, into the recording medium 105, and manages inputting of the compressively encoded data into the decompressively decoding unit 106, in accordance with the information indicating whether the signal can be compressively encoded or not, which is given from the compressively uncodable signal detection unit 102.

The decompressively decoding unit 106 decompressively decodes the inputted compressively encoded data. The D/A conversion unit 107 converts the inputted digital data into an analog video/audio signal, and outputs the signal.

Next, a description will be given of the operation of the information receiving/recording/reproduction apparatus according to the first embodiment having the aforementioned configuration for recording an analog video/audio signal into the recording medium 105.

An analog video/audio signal that is inputted in the information receiving/recording/reproduction apparatus is converted into digital data by the A/D conversion unit 101, and inputted to the compressively encoding unit 103. Simultaneously, the digital video data which has been digitally converted in the A/D conversion unit 102 is inputted to the compressively uncodable signal detection unit 102, and the horizontal components and vertical components are checked therein. Then, from the result of the checking, it is decided whether the inputted analog video/audio signal can be compressively encoded or not, and information indicating whether the analog video/audio signal can be compressively encoded or not is inputted to the compressively encoding unit 103 and the recording/reproduction management unit 104.

The compressively encoding unit 103 compressively encodes the digital data outputted from the A/D conversion unit 101 in accordance with the information indicating whether the signal can be compressively encoded or not, which is outputted from the compressively uncodable signal detection unit 102, and outputs the compressively encoded data to be recorded in the recording medium 105 under management of the recording/reproduction management unit 104.

Here, among the above-mentioned operations of the information receiving/recording/reproduction apparatus according to the first embodiment, the operations of the compressively uncodable signal detection unit 102, the compressively encoding unit 103, and the recording/reproduction management unit 104 are described in more detail with reference to FIGS. 2 to 5.

Initially, the operation of the compressively uncodable signal detection unit 102 for outputting the information indicating whether the inputted analog video/audio signal can be compressively encoded or not will be described with reference to a flowchart shown in FIG. 2.

FIG. 2 is a flowchart showing a series of processes of the compressively uncodable signal detection unit in the information receiving/recording/reproduction apparatus according to the first embodiment.

Initially in step 201, digital video data that is outputted from the A/D conversion unit 101 is received. Then in step 202, the number of data corresponding to one horizontal line (NumOfH) of the received digital video data is obtained.

In step 203, the obtained number of data corresponding to one line (NumOfH) is compared with a prescribed number of data (HVal) corresponding to one line, that is defined by the standardization associated with the analog video signal. When they are not equal to each other, it is decided that the signal cannot be compressively encoded, and the operation proceeds to step 207 in which the information indicating that the inputted analog video/audio signal cannot be compressively encoded is given to the compressively encoding unit 103 and the recording/reproduction management unit 104. On the other hand, when the obtained number of data corresponding to one line (NumOfH) is equal to the prescribed number of data per line (HVal) defined by the standardization associated with the analog video signal in step 203, the operation proceeds to step 204.

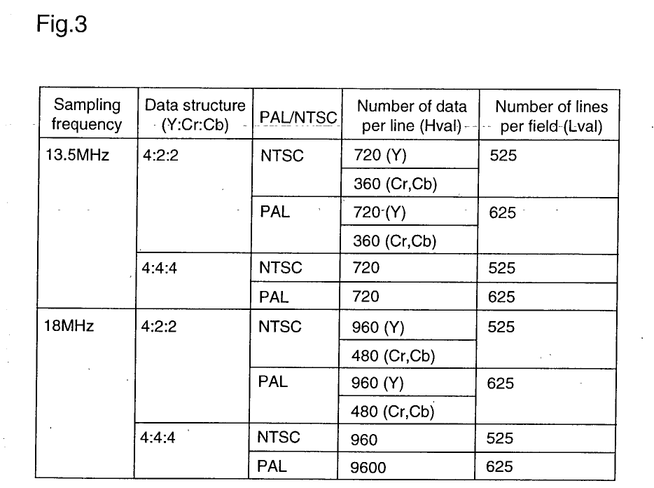

Here, the prescribed number of data per line (HVal) as a target to be compared in step S203 has values varying with standards. FIG. 3 shows prescribed numbers of data per line (HVal) according to ITU-R BT.601-5 that is a standard associated with a typical video signal.

Then in step 204, the number of lines corresponding to one vertical field (NumOfL) of the digital video data that is outputted from the A/D conversion unit 101 is obtained. Instep 205, the number of lines corresponding to one field (NumOfL) obtained in step 204 is compared with a prescribed number of lines per field (LVal), which is defined by the standard associated with the analog video signal. When they are not equal to each other, it is decided that the signal cannot be compressively encoded, and the operation proceeds to step 207 in which the information indicating that the inputted analog video/audio signal cannot be compressively encoded is given to the compressively encoding unit 103 and the recording/reproduction management unit 104. On the other hand, when the obtained number of lines corresponding to one field (NumOfL) is equal to the prescribed number of lines per one field (LVal) defined by the standard associated with the analog video signal in step 205, it is decided that the signal can be compressively encoded. Then in step 206, information indicating that the inputted analog video/audio signal can be compressively encoded is given to the compressively encoding unit 103 and the recording/reproduction management unit 104.

Here, the prescribed number of lines per field (LVal) as a target to be compared in step 205 has values varying with standards, like the prescribed number of data per line (HVal). FIG. 3 shows prescribed numbers of lines per field (LVal) according to ITU-RBT.601-5 that is the standard associated with the typical video signal.

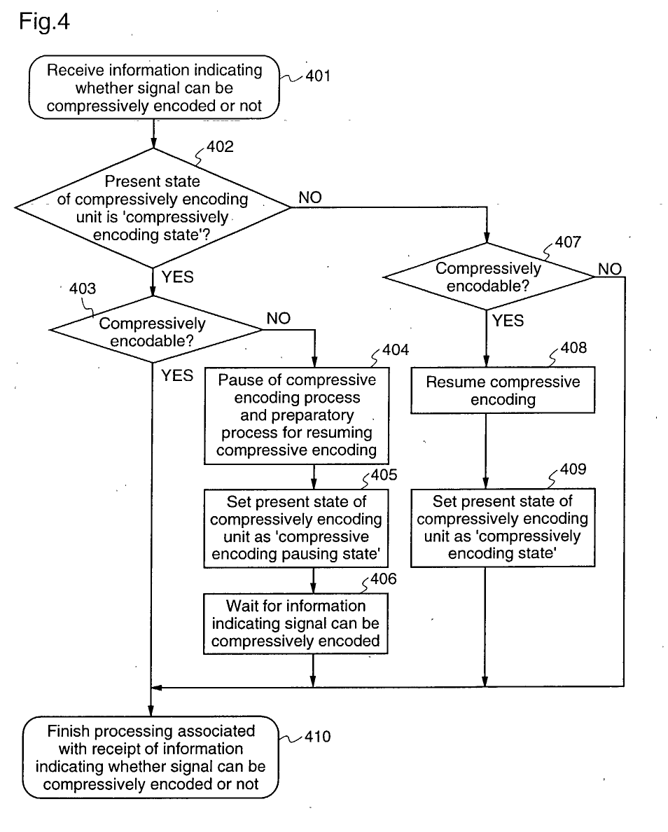

Next, the operation of the compressively encoding unit 103 when the information indicating whether the analog video/audio signal can be compressively encoded or not is given thereto will be described, with reference to a flowchart shown in FIG. 4.

FIG. 4 is a flowchart showing the operation of the compressively encoding unit according to the first embodiment when the information indicating whether the inputted analog video/audio signal can be compressively encoded or not is given thereto.

Initially, when the information indicating whether the signal can be compressively encoded or not, which is outputted from the compressively uncodable signal detection unit 102, is received by the compressively encoding unit 103 in step 401, the present state of the compressively encoding unit 103 and the contents of the information indicating whether the signal can be compressively encoded or not, which is given to the compressively encoding unit 103 are checked in steps 402, 403 and 407.

When the present state of the compressively encoding unit 103 in step 402 is a “compressively encoding state”, and it is decided in step 403 that information indicating that the signal can be compressively encoded is given, the operation proceeds to step 410, thereby leading to finish the processing associated with the receipt of information indicating whether the signal can be compressively encoded or not, without performing special processing.

When the present state of the compressively encoding unit 103 in step S402 is a “compressively encoding state”, and it is decided in step 403 that information indicating that the signal cannot be compressively encoded is given, the operation proceed to step 404, in which the compressive encoding process is paused, and a preparatory process for resuming compressive encoding when a compressively encodable analog video/audio signal is inputted again is carried out. In step 405, the present state of the compressively encoding unit 103 is set at a “compressive encoding pausing state”. Then, a process of waiting for notification of the information indicating that the signal can be compressively encoded is carried out in step 406, and thereafter the processing associated with the receipt of the information indicating whether the signal can be compressively encoded or not is finished in step 410.

Further, when the present state of the compressively encoding unit 103 in step 402 is a “compressive encoding pausing state”, and it is decided in step 407 that information indicating that the signal can be compressively encoded is given, the operation proceeds to step 408, thereby resuming the compressive encoding process. Then in step 409, the present state of the compressively encoding unit 103 is set at a “compressively encoding state”, and thereafter the processing associated with the receipt of the information indicating whether the signal can be compressively encoded or not is finished in step 410.

Further, when the present state of the compressively encoding unit 103 in step 402 is a “compressive encoding pausing state”, and it is decided in step 407 that information indicating that the signal cannot be compressively encoded is given, the operation proceed to step 410, thereby leading to finish the processing associated with receipt of the information indicating whether the signal can be compressively encoded or not, without performing special processing.

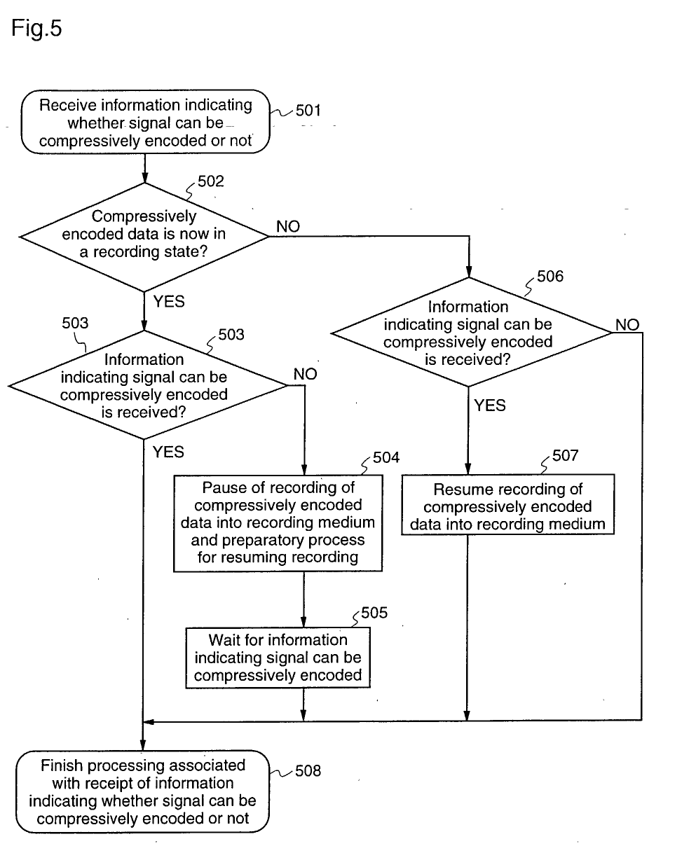

Then, the operation of the recording/reproduction management unit 104 when the information indicating whether an analog video/audio signal can be compressively encoded or not is given thereto will be described, with reference to a flowchart shown in FIG. 5.

FIG. 5 is a flowchart showing the operation of the recording/reproduction management unit 104 in the first embodiment when the information indicating whether the inputted analog video/audio signal can be compressively encoded or not is given thereto.

Initially, when the information indicating whether the signal can be compressively encoded or not, which is outputted from the compressively uncodable signal detection unit 102 is received by the recording/reproduction management unit 104 in step 501, the present recording state of the compressively encoded data and the contents of the information indicating whether the signal can be compressively encoded or not, which has been given to the recording/reproduction management unit 104 are checked in steps 502, 503, and 506.

When the compressively encoded data is now in a recording state in step 502, and the information indicating that the signal can be compressively encoded is given in step 503, the operation proceeds to step 508, thereby leading to finish the processing associated with the receipt of information whether the signal can be compressively encoded or not, without performing special processing.

When the compressively encoded data is now in a recording state in step 502, and the information indicating that the signal cannot be compressively encoded is given in step 503, the operation proceeds to step 504 where the recording of the compressively encoded data into the recording medium 105 is paused, and a preparatory process for resuming recording of compressively encoded data into the recording medium 105 is carried out when a compressively encodable analog video/audio signal is inputted again. Here, the preparatory process for resuming the recording process indicates a process of eliminating compressively encoded data that is recorded in the recording medium 105 up to a portion in which a data structure that is capable of decompressive decoding at the reproduction is ensured, to adjust the data structure. Then in step 505, a process of waiting for notification of the information indicating that the signal can be compressively encoded is performed, and the operation proceeds to step 508, thereby leading to finish the processing associated with the receipt of the information indicating whether the signal can be compressively encoded or not.

As described above, in the operation for recording an analog video/audio signal into the recording medium 105, the compressively uncodable signal detection unit 102 checks the horizontal and vertical components of digital video data that has been outputted from the A/D conversion unit 101, to decide whether the analog video/audio signal can be compressively encoded or not. However, the decision as to whether the analog video/audio signal can be compressively encoded or not may be made in the compressively uncodable signal detection unit by checking the compressive encoding state in the compressively encoding unit.

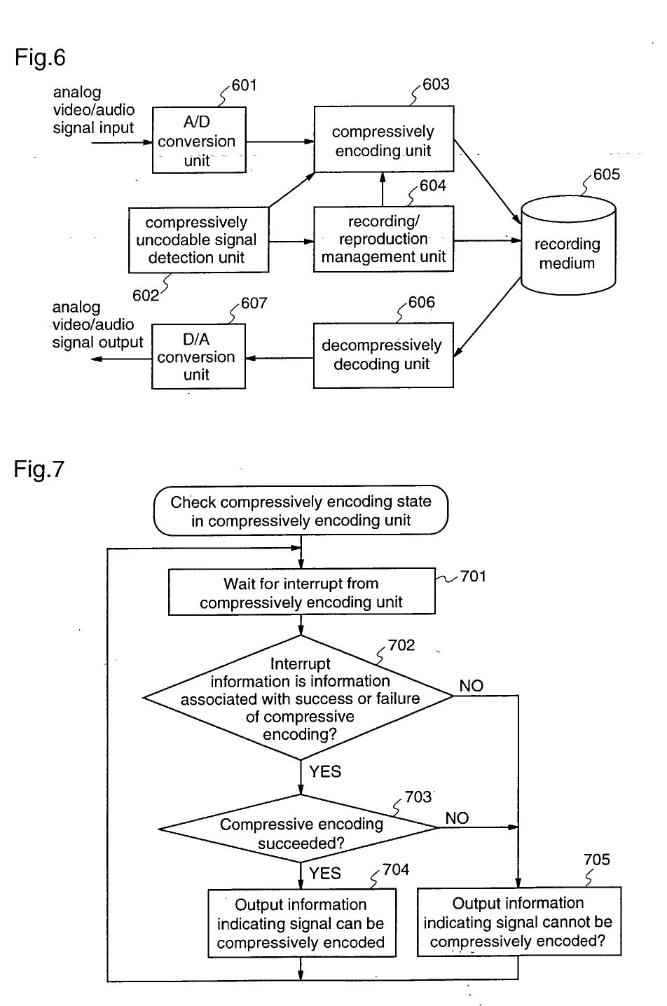

Hereinafter, an information receiving/recording/reproduction method and an information receiving/recording/reproduction apparatus in cases where the decision as to whether an analog video/audio signal can be compressively encoded or not is made according to the compressive encoding state in the compressively encoding unit will be described, with reference to FIG. 6, as a first variation of the first embodiment.

[Variation 1 of Embodiment 1]

FIG. 6 is a diagram illustrating a structure of an information receiving/recording/reproduction apparatus according to the first variation of the first embodiment.

In this figure, the information receiving/recording/reproduction apparatus according to the first variation of the first embodiment comprises an A/D conversion unit 601, a compressively uncodable signal detection unit 602, a compressively encoding unit 603, a recording/reproduction management unit 604, a recording medium 605, a decoding unit 606, and a D/A conversion unit 607. The compressively uncodable signal detection unit 602 checks a state of compressive encoding in the compressively encoding unit 603, decides whether an inputted analog video/audio signal can be compressively encoded or not, and outputs information indicating whether the signal can be compressively encoded or not.

The structures of other elements are the same as those described in the first embodiment with reference to FIG. 1, and accordingly their descriptions are omitted here.

Next, the operation of the information receiving/recording/reproduction apparatus according to the first variation of the first embodiment having the aforementioned structure for recording an analog video/audio signal in the recording medium 605 will be described.

Initially, an analog video/audio signal that is inputted to the information receiving/recording/reproduction apparatus is converted into digital data by the A/D conversion unit 601, and outputted to the compressively encoding unit 603. The digital data is compressively encoded by the compressively encoding unit 603, and the compressive encoded state of the data is checked by the compressively uncodable signal detection unit 602. Then, from the result of the checking, it is decided whether the inputted analog video/audio signal can be compressively encoded or not, and information indicating whether the analog video/audio signal can be compressively encoded or not is outputted to the recording/reproduction management unit 604.

The compressively encoded data that is outputted from the compressively encoding unit 603 is recorded in the recording medium 605 while being managed by the recording/reproduction management unit 604 in accordance with the information whether the signal can be compressively encoded or not, which is outputted from the compressively uncodable signal detection unit 602.

The operation of the compressively uncodable signal detection unit 602 for outputting the information indicating whether the inputted analog video/audio signal can be compressively encoded or not will be described with reference to a flowchart shown in FIG. 7.

FIG. 7 is a flowchart showing the operation of the compressive encoding signal detection unit according to the first variation of the first embodiment, for obtaining the information indicating whether the signal can be compressively encoded or not, on the basis of the compression state in the compressive encoding unit.

Initially in step 701, a compressive encoding state of the digital data in the compressively encoding unit 603 is checked, and the compressively uncodable signal detection unit stands by until an interrupt notifying that exception at the compressive encoding process occurs is inputted from the compressively encoding unit 603. Then, when the interrupt is inputted from the compressively encoding unit 603, it is checked in step 702 whether the interrupt is caused by the notification of information about success or failure of the compressive encoding process. When the interrupt is caused by the notification of information about success or failure of the compressive encoding process, the operation proceeds to step 703. In step 703, it is decided whether the interrupt information in step 702 is information indicating success of the compressive encoding process, or information indicating failure of the compressive encoding process. When the information indicates success of the compressive encoding process, the operation proceeds to step 704, in which information indicating that the analog video/audio signal can be compressively encoded is outputted to the recording/reproduction management unit 604. On the other hand, when it is decided in step 703 that the interrupt information in step 702 shows failure of the compressive encoding process, the operation proceeds to step 705 in which information indicating that the analog video/audio signal cannot be compressively encoded is outputted to the recording/reproduction management unit 604.

As described above, in the operation for recording an analog video/audio signal in the recording medium 605 according to the first variation of the first embodiment, the compressively uncodable detection unit 602 checks a compressive encoding state in the compressively encoding unit 603, thereby deciding whether the analog video signal can be compressively encoded or not. However, the decision as to whether the analog video/audio signal can be compressively encoded or not may be made in the compressively uncodable signal detection unit by detecting a horizontal sync signal in the analog video/audio signal and checking whether the horizontal sync signal is detected at given time intervals.

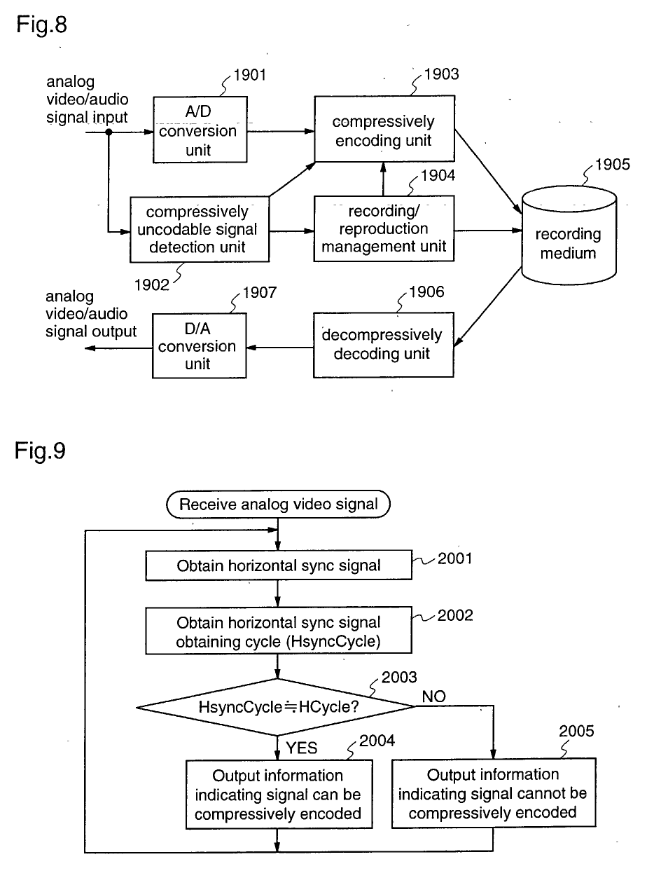

Hereinafter, an information receiving/recording/reproduction method and an information receiving/recording/reproduction apparatus in cases where a horizontal sync signal of an analog video/audio signal is detected and then the decision as to whether an analog video signal can be compressively encoded or not is made according to whether the horizontal sync signal is detected at given time intervals or not will be described with reference to FIG. 8, as a second variation of the first embodiment.

[Variation 2 of Embodiment 1]

FIG. 8 is a diagram illustrating an information receiving/recording/reproduction apparatus according to the second variation of the first embodiment.

In this figure, the information receiving/recording/reproduction apparatus according to the first embodiment comprises an A/D conversion unit 1901, a compressively uncodable signal detection unit 1902, a compressively encoding unit 1903, a recording/reproduction management unit 1904, a recording medium 1905, a decompressively decoding unit 1906, and a D/A conversion unit 1907. The compressively uncodable signal detection unit 1902 detects a horizontal sync signal in the analog video/audio signal, checks whether the horizontal sync signal is detected at given time intervals, and decides whether the inputted analog video/audio signal can be compressively encoded or not, thereby detecting, information indicating whether the signal can be compressively encoded or not.

The structures of other elements are the same as those described in the first embodiment with reference to FIG. 1, and their descriptions are omitted here.

Next, the operation of the information receiving/recording/reproduction apparatus according to the second variation of the first embodiment having the aforementioned configuration, for recording an analog video/audio signal in the recording medium 1905 will be described.

Initially, an analog video/audio signal that is inputted to the information receiving/recording/reproduction apparatus is converted into digital data by the A/D conversion unit 1901, and outputted to the compressively encoding unit 1903. Simultaneously, the analog video/audio signal that is inputted to the information receiving/recording/reproduction apparatus is inputted to the compressively uncodable signal detection unit 1902. The compressively uncodable signal detection unit 1902 detects a horizontal sync signal of the analog video/audio signal, checks whether the horizontal sync signal is detected at given time intervals, and decides whether the inputted analog video/audio signal can be compressively encoded or not on the basis of the result of the checking, thereby outputting information indicating whether the analog video/audio signal can be compressively encoded or not to the compressively encoding unit 1903 and the recording/reproduction management unit 1904.

The compressively encoding unit 1903 compressively encodes the digital data outputted from the A/D conversion unit 101 in accordance with the information indicating whether the signal can be compressively encoded or not, which is outputted from the compressively uncodable signal detection unit 1902, and outputs the compressively encoded data to be recorded in the recording medium 1905 under management of the recording/reproduction management unit 1904.

The operation of the compressively uncodable signal detection unit 1902 for outputting the information indicating whether the inputted analog video/audio signal can be compressively encoded or not will be described with reference to FIGS. 9 to 11.

FIG. 9 is a flowchart showing a series of operation of the compressively uncodable detection unit in the information receiving/recording/reproduction apparatus according to the second variation of the first embodiment.

Initially in step 2001, a horizontal sync signal is detected from an inputted analog video signal.

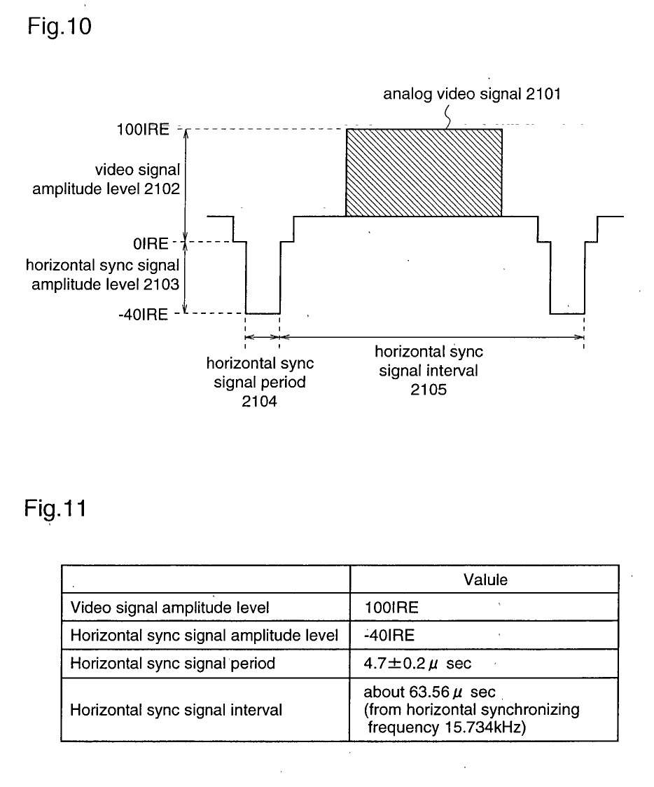

The detection of a horizontal sync signal in the analog video signal will be described here. FIG. 10 shows specifications of an analog video signal (standardization RS-170A which are standards and specifications of the television signal, published by IEA in U.S. (Electronic Industries Association)). In this figure, the analog video signal is represented in IRE (Institute of Radio Engineers) units. This unit represents not an absolute value but a ratio, and the level of the analog video signal up to white 100% (completely white) is expressed by 100 IRE units.

The detection of the horizontal sync signal is performed by detecting a value of a horizontal sync amplitude level 2103 and a horizontal sync signal period 2104. Here, FIG. 11 shows values of the items shown in FIG. 10, in the NTSC format applied to a color television signal in Japan or in the U.S.

Then, in step 2002, an interval between the horizontal sync signal detected in step 2001 and a horizontal sync signal that has been detected immediately before, i.e., a horizontal sync signal obtaining cycle (Hsync Cycle) is obtained. Then, instep S2003, the horizontal sync signal obtaining cycle (Hsync Cycle) obtained in step 2002 is compared with a horizontal sync signal cycle (HCycle) based on the standards. When they have the same value, it is decided that the signal can be compressively encoded, and then the operation proceeds to step 2004, thereby outputting information indicating that the inputted analog video/audio signal can be compressively encoded to the compressively encoding unit 1903 and the recording/reproduction management unit 1904. On the other hand, when the horizontal sync signal obtaining cycle (Hsync Cycle) obtained in step 2002 is not equal to the horizontal sync signal cycle (HCycle) based on the standard in step 2003, it is decided that the analog video/audio signal cannot be compressively encoded. Then, the operation proceeds to step 2004, thereby outputting information indicating that the inputted analog video/audio signal cannot be compressively encoded to the compressively encoding unit 1903 and the recording/reproduction management unit 1904.

As described above, according to the first embodiment and its variations of the present invention, the recording/reproduction management unit manages the state of the compressively encoded data recorded/reproduced to/from the recording medium, in accordance with the information indicating whether the signal can be compressively encoded or not, which is obtained by the compressively uncodable signal detection unit. Therefore, even when an analog video/audio signal inputted to the information receiving/recording/reproduction apparatus cannot be compressively encoded, the data structure can be prevented from being broken at the interrupt and resumption point of the recording in the recording medium. Accordingly, when the compressively encoded data in the recording medium is decompressively decoded to be reproduced, the disturbance of images or freeze of the system can be avoided.

Embodiment 2.

Hereinafter, a second embodiment of the present invention will be described with reference to FIGS. 1, 2, and 12 to 15.

According to an information receiving/recording/reproduction apparatus according to the second embodiment, the recording/reproduction management unit according to the first embodiment includes a data management means for managing compressively encoded data that is recorded in a recording medium, thereby performing management so that the compressively encoded data that is recorded in the recording medium surely has a decompressively decodable data structure.

Initially, a structure of the information receiving/recording/reproduction apparatus according to the second embodiment will be described with reference to FIG. 1.

The structure of the information receiving/recording/reproduction apparatus according to the second embodiment is the same as that in the first embodiment, while the recording/reproduction management unit 104 manages recording of compressively encoded data that is outputted from the compressively encoding unit 103 into the recording medium 105 and inputting of the compressively encoded data into the decompressively decoding unit 106, and further manages the compressively encoded data that is recorded in the recording medium 105, in accordance with the information given by the compressively uncodable signal detection unit 102.

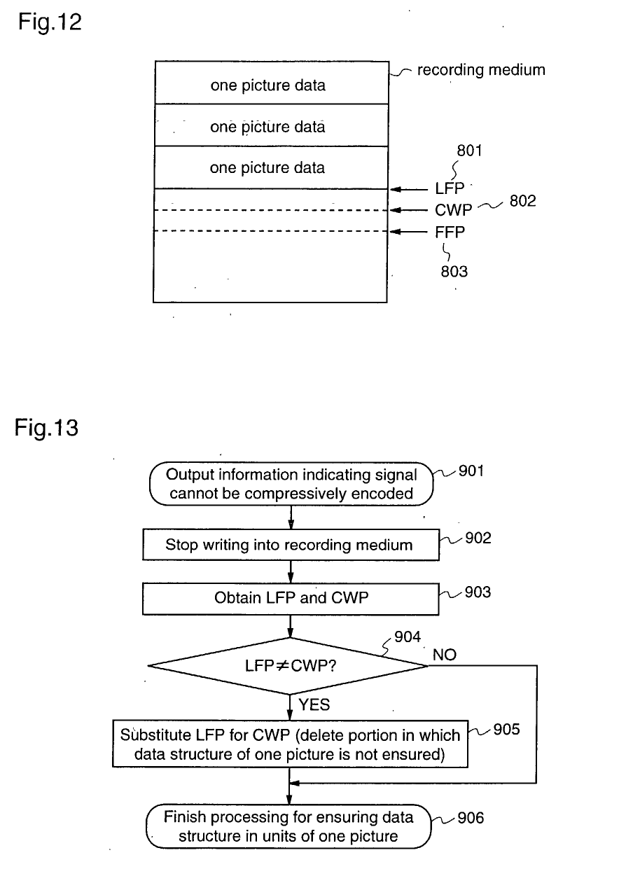

Here, with reference to FIG. 12, a description will be given of a state in the recording medium 105 in cases where the recording/reproduction management unit 104 according to the second embodiment manages the compressively encoded data that is recorded in the recording medium 105 while ensuring the data structure in units of one picture.

FIG. 12 is a diagram illustrating a structure of the compressively encoded data in the recording medium according to the second embodiment, which is recorded in the data structure in units of one picture.

In this figure, Latest Data Fix Point 801 denotes a boundary point of the latest compressively encoded data in which a data structure in units of one picture unit is ensured. Current Data Write Point 802 denotes a point at which data is now being written. Future Data Fix Point 803 denotes a boundary point of compressively encoded data when writing of one picture data that is now being written is completed. Here, when one picture data size does not have a fixed length, the Future Data Fix Point 803 is not determined until the writing of one picture data is completed.

Next, the operation of the information receiving/recording/reproduction apparatus according to the second embodiment having the aforementioned structure for recording an analog video/audio signal in the recording medium 105 will be described.

A series of operations of the information receiving/recording/reproduction apparatus according to the second embodiment for recording an analog video/audio signal in the recording medium 105 are similar to those in the first embodiment, while the operation of the information receiving/recording/reproduction apparatus according to the second embodiment is different in that when compressively encoded data are recorded in the recording medium 105 under management of the recording/reproduction management unit 104 in accordance with the information outputted from the compressively uncodable signal detection unit 102, the compressively encoded data are managed for always being recorded in units of one picture.

Here, with reference to a flowchart shown in FIG. 13, a description will be given of an operation of the recording/reproduction management unit 104 for ensuring that the compressively encoded data that is being recorded in the recording medium 105 has the data structure in units of one picture (corresponding to step 504 in FIG. 5), when the information indicating that the signal cannot be compressively encoded is inputted from the compressively uncodable signal detection unit 102 to the recording/reproduction management unit 104 while the compressively encoded data is being recorded in the recording medium 105.

Initially, when the information indicating that the analog video/audio signal cannot be compressively encoded is outputted from the compressively uncodable signal detection unit 102 in step 901, writing into the recording medium 105 is stopped in step 902. Then in step 903, the Latest Data Fix Point (LFP) 801 and the Current Data Write Point (CWP) 802 are obtained.

Then in step 904, the Latest Data Fix Point (LFP) 801 and the Current Data Write Point (CWP) 802 which are obtained in step 903 are compared with each other. When the Latest Data Fix Point (LFP) 801 is smaller than the Current Data Write Point (CWP) 802, i.e., when the Latest Data Fix Point (LFP) 801 is not equal to the Current Data Write Point (CWP) 802, a process is carried out in step 905 for substituting the value of the Latest Data Fix Point (LFP) 801 for the value of the Current Data Write Point (CWP) 802 to delete compressively encoded data which does not have the data structure in units of one picture, thereby putting the position of the Current Data Write Point (CWP) 802 back to the position of the Latest Data Fix Point (LFP) 801.

In step 904, a case where the Latest Data Fix Point (LFP) 801 is larger than the Current Data Write Point (CWP) 802 does not occur normally, but if the Latest Data Fix Point (LFP) 801 is larger than the Current Data Write Point (CWP) 802, this is processed as an error, or a process of substituting the value of the Latest Data Fix Point (LFP) 801 for the Current Data Write Point (CWP) 802 is carried, whereby the data structure in units of one picture is always secured.

On the other hand, when the Latest Data Fix Point (LFP) 801 is equal to the Current Data Write Point (CWP) 802 in step 904, the compressively encoded data that is recorded in the recording medium 105 already has the data structure in units of one picture. Thus, in step 906, the processing for securing the data structure in units of one picture is finished.

In the above descriptions, the compressively encoded data that is recorded in the recording medium 105 is managed by the recording/reproduction management unit 104 for securely having the data structure in units of one picture. However, the recording/reproduction management unit 104 may manage the compressively encoded data for having a data structure in units of one GOP.

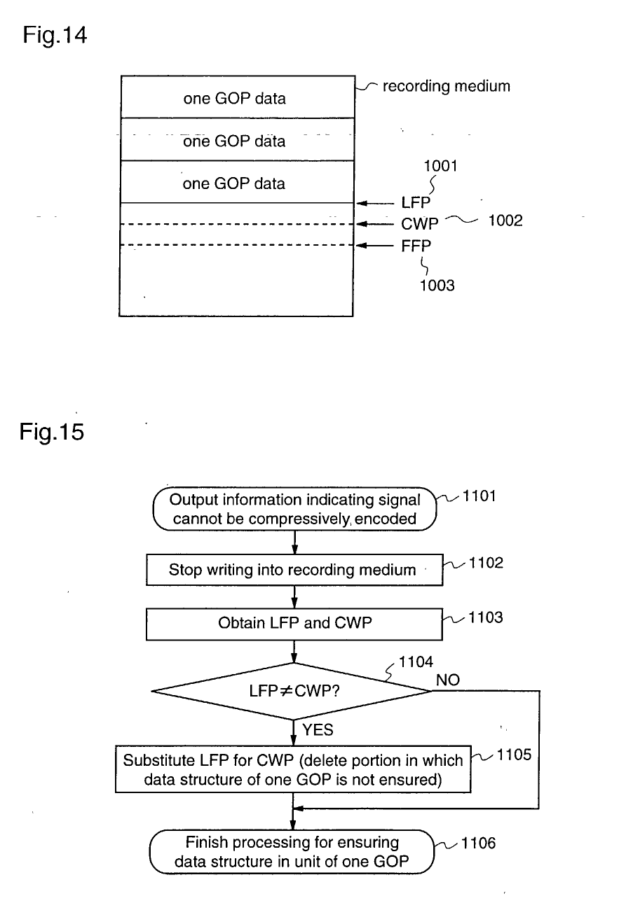

Hereinafter, a state of data in the recording medium 105 when the compressively encoded data that is recorded in the recording medium 105 is managed by the recording/reproduction management unit 104 of the second embodiment for securely having the data structure in units of one GOP will be described, with reference to FIG. 14.

FIG. 14 is a diagram illustrating a structure of the compressively encoded data that is recorded in a data structure in units of one GOP in the recording medium according to the second embodiment.

In this figure, a Latest Data Fix Point 1001 denotes a boundary point of the latest compressively encoded data that ensures a data structure in units of one GOP. A Current Data Write Point 1002 denotes a point in which data is now being written. A Future Data Fix Point 1003 denotes a boundary point of compressively encoded data when the writing of one GOP data that is now being written is completed. When one GOP data size is not of a fixed length, the Future Data Fix Point 1003 is not determined until writing of one GOP data is completed and not determined until writing of one picture data is completed when not being of a fixed length.

Here, with reference to a flowchart shown in FIG. 15, a description will be given of an operation of the recording/reproduction management unit 104 for ensuring that the compressively encoded data that is being recorded in the recording medium 105 has a data structure in units of one GOP (corresponding to step 504 in FIG. 5), when information indicating that the signal cannot be compressively encoded is outputted from the compressively uncodable signal detection unit 102 to the recording/reproduction management unit 104 while the compressively encoded data is being recorded in the recording medium 105.

Initially, when the information indicating that the analog video/audio signal cannot be compressively encoded is outputted from the compressively uncodable signal detection unit 102 in step 1101, writing into the recording medium 105 is stopped in step 1102. Then in step 1103, the Latest Data Fix Point (LFP) 1001 and the Current Data Write Point (CWP) 1002 are obtained.

Then, in step 1104, the Latest Data Fix Point (LFP) 1001 and Current Data Write Point (CWP) 1002 which are obtained in step 1103 are compared with each other. When the Latest Data Fix Point (LFP) 1001 is smaller than the Current Data Write Point (CWP) 1002, i.e., when the Latest Data Fix Point (LFP) 1001 is not equal to the Current Data Write Point (CWP) 1002, a process is carried out in step 1105 for substituting the value of the Latest Data Fix Point (LFP) 1001 for the Current Data Write Point (CWP) 1002 to delete compressively encoded data that does not have the data structure in units of one GOP, thereby putting the position of the Current Data Write Point (CWP) 1002 back to the position of the Latest Data Fix Point LFP) 1001.

A case where the Latest Data Fix Point (LFP) 1001 becomes larger than the Current Data Write Point (CWP) 1002 does not occur normally in step 1104, but if the Latest Data Fix Point (LFP) 1001 is larger than the Current Data Write Point (CWP) 1002, this is processed as an error, or a process for substituting the Latest Data Fix Point (LFP) 1001 for the Current Data Write Point (CWP) 1002 is carried out, thereby always securing the data structure in units of one GOP.

On the other hand, when the Latest Data Fix Point (LFP) 1001 is equal to the Current Data Write Point (CWP) 1002 in step 1104, the compressively encoded data that is recorded in the recording medium 105 already has the data structure in units of one GOP. Therefore, in step 1106, the processing for securing the data structure in units of one GOP is finished.

As described above, according to the second embodiment, the compressively encoded data that are to be recorded and retained in the recording medium 105 are managed by the recording/reproduction management unit 104 to be recorded with always ensuring the data structure in units of one picture or one GOP. Therefore, even when the inputted analog video/audio signal cannot be compressively encoded, the data structure in the recording medium 105 is prevented from being broken at the interrupt and resumption points of the recording. Consequently, when the compressively encoded data in the recording medium 105 is decompressively decoded to be reproduced, the disturbance of images or freeze of the system can be avoided.

In the compressively uncodable signal detection unit 102 according to the second embodiment, the horizontal components and vertical components of the digital video data that is outputted from the A/D conversion unit 101 are checked, thereby to decide whether the inputted analog video/audio signal can be compressively encoded or not. However, the decision as to whether the inputted analog video/audio signal can be compressively encoded or not may be made, as described in the first variation of the first embodiment, in the compressively uncodable signal detection unit 102 by checking the compressive encoding state in the compressively encoding unit 103, or may be made, as described in the second variation of the first embodiment, in the compressively uncodable signal detection unit 102 by detecting a horizontal sync signal in the inputted analog video/audio signal and checking whether the horizontal sync signal is detected at given time intervals or not.

Embodiment 3.

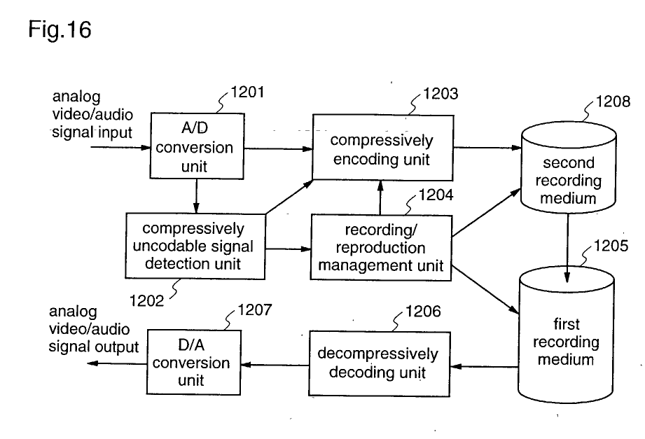

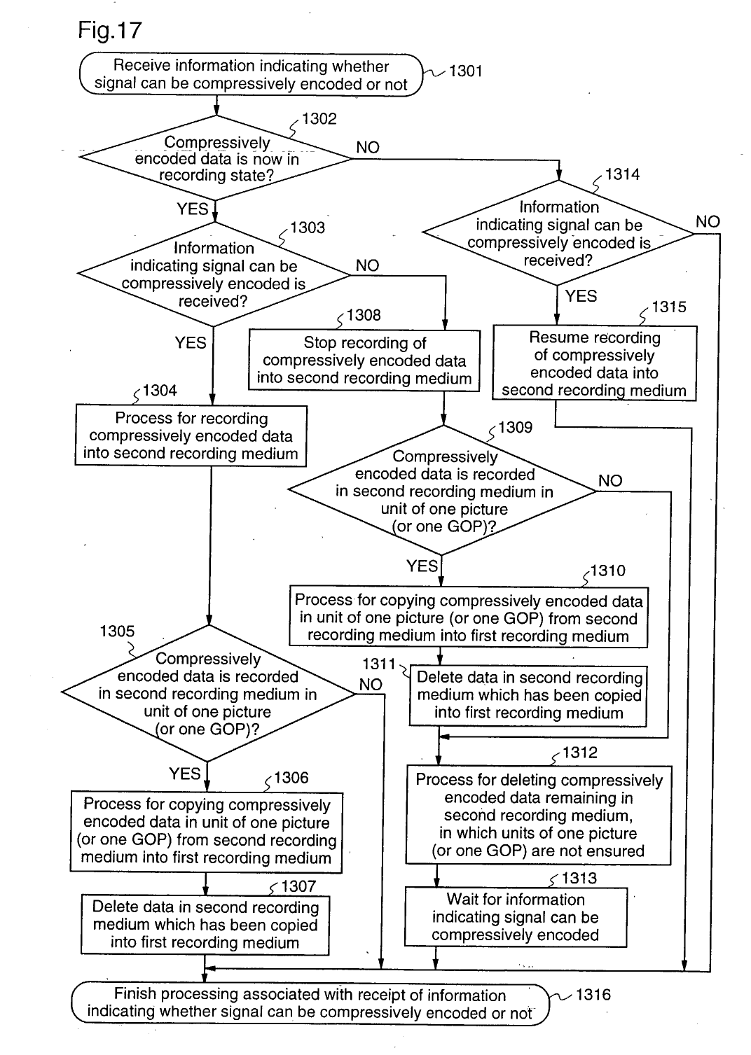

Hereinafter, a third embodiment of the present invention will be described with reference to FIGS. 16 and 17.

An information receiving/recording/reproduction apparatus according to the third embodiment further includes a second recording medium that is randomly accessible at a speed higher than that of the first recording medium in which compressively encoded data is recorded, and the recording/reproduction management unit according to the first embodiment includes a data management means for temporarily storing the compressively encoded data in the second recording medium and thereafter recording the stored compressively encoded data in the first recording medium while ensuring a decompressively decodable data structure.

Initially, a structure of the information receiving/recording/reproduction apparatus according to the third embodiment will be described with reference to FIG. 16.

FIG. 16 is a block diagram illustrating the structure of the information receiving/recording/reproduction apparatus according to the third embodiment.

In this figure, the information receiving/recording/reproduction apparatus according to the third embodiment comprises an A/D conversion unit 1201, a compressively uncodable signal detection unit 1202, a compressively encoding unit 1203, a recording/reproduction management unit 1204, a first recording medium 1205, a decompressively decoding unit 1206, a D/A conversion unit 1207, and a second recording medium 1208.

The second recording medium 1208 is randomly accessible at a speed higher than that of the first recording medium 1205. The recording/reproduction management unit 1204 manages recording of compressively encoded data that is outputted from the compressively encoding unit 1203 to the second recording medium 1208, recording of the compressively encoded data from the second recording medium 1208 to the first recording medium 1205, and inputting of the compressively encoded data into the decompressively decoding unit 1206, in accordance with the information indicating that the signal can be compressively encoded or not, which is outputted from the compressively uncodable signal detection unit 1202. Other elements are the same as those in the first embodiment, and therefore their descriptions are omitted here.

Next, the operation of the information receiving/recording/reproduction apparatus according to the third embodiment having the above-mentioned configuration, for recording an analog video/audio signal in the first recording medium 1205 will be described.

The analog video/audio signal that is inputted to the information receiving/recording/reproduction apparatus is converted into digital data by the A/D conversion unit 1201, and outputted to the compressively encoding unit 1203. Simultaneously, horizontal components and vertical components of the digital video data that has been converted into digital by the A/D conversion unit 1201 are checked by the compressively uncodable signal detection unit 1202. From a result of the checking, it is decided whether the inputted analog video/audio signal can be compressively encoded or not, and information indicating that the analog video/audio signal can be compressively encoded or not is outputted to the compressively encoding unit 1203 and the recording/reproduction management unit 1204.

Then, the compressively encoding unit 1203 compressively encodes the digital data from the A/D conversion unit 101 to output compressively encoded data, in accordance with the information indicating that the signal can be compressively encoded or not, which is outputted from the compressively uncodable signal detection unit 1202, and temporarily stores the compressively encoded data in the second recording medium 1208 under management of the recording/reproduction management unit 1204. After being managed to have a decompressively decodable data structure, the compressively encoded data stored in the second recording medium 1208 is recorded in the first recording medium 1205.

The operation in the recording/reproduction management unit 1204 when the information indicating that the inputted analog video/audio signal can be compressively encoded or not is given from the compressively uncodable signal detection unit 1202 will be described with reference to a flowchart shown in FIG. 17.

FIG. 17 is a flowchart showing an operation of the recording/reproduction management unit according to the third embodiment, when the information indicating that the inputted analog video/audio signal can be compressively encoded or not is given thereto.

Initially, when the information indicating that the signal can be compressively encoded or not, which is outputted from the compressively uncodable signal detection unit 1202 is received by the recording/reproduction management unit 1204 in step 1301, a present recording state of the compressively encoded data and the contents of the information indicating whether the signal can be compressively encoded or not, which is given to the recording/reproduction management unit 1204 are checked in steps 1302, 1303 and 1314.

When the compressively encoded data is now in a recording state in step 1302 and information indicating that the signal can be compressively encoded is given in step 1303, the operation proceeds to step 1304, in which a process for recording the compressively encoded data in the second recording medium 1208 is carried out. Then in step 1305, it is checked whether the compressively encoded data is recorded in the second recording medium 1208 in units of one picture or one GOP. When such data exists, the operation proceeds to step 1306, in which a process for copying the compressively encoded data from the second recording medium 1208 into the first recording medium 1205 in units of one picture or one GOP is carried out, and the compressively encoded data is retained in the first recording medium in units of one picture or one GOP. Then in step 1307, the compressively encoded data which is recorded in the second recording medium 1208 and has been copied into the first recording medium 1205 in step 1306, is abandoned after the copying, and then the operation proceeds to step 1316, thereby leading to finishing the processing associated with the receipt of information indicating whether the signal can be compressively encoded or not.

When the compressively encoded data is now in a recording state in step 1302 and information indicating that the signal cannot be compressively encoded is given in step 1303, the recording of the compressively encoded data into the second recording medium 1208 is initially stopped in step 1308. Thereafter, whether or not the compressively encoded data is recorded in the second recording medium 1208 in units of one picture or one GOP is checked in step 1309. When such data exists, the operation proceeds to step 1310 in which a process for copying the compressively encoded data from the second recording medium 1208 into the first recording medium 1205 in units of one picture or one GOP is carried out, thereby storing the compressively encoded data in the first recording medium 1205 in units of one picture or one GOP. Then in step 1311, the compressively encoded data that is recorded in the second recording medium 1208 and has been copied into the first recording medium 1205 in step 1310 is abandoned after the copying. Then in step 1312, compressively encoded data which does not have the data structure in units of one picture or one GOP in the second recording medium 1208 is deleted, and preparation is made for immediately resuming recording of compressively encoded data into the second recording medium 1208 when a compressively encodable analog video/audio signal is inputted again. Then, a process for waiting for notification of information indicating that the signal can be compressively encoded is carried out in step 1313, and thereafter the processing associated with the receipt of the information indicating whether the signal can be compressively encoded or not is finished in step 1316.

When the compressively encoded data is now in a record pausing state in step 1302 and information indicating that the signal can be compressively encoded is given in step 1314, recording of the compressively encoded data into the second recording medium 1208 is resumed in step 1315, and the processing associated with the receipt of the information indicating whether the signal can be compressively encoded or not is finished in step 1316.

When the compressively encoded data is now in a record pausing state in step 1302 and information indicating the signal cannot be compressively encoded is given in step 1314, the operation proceeds to step 1316, thereby leading to finish the processing associated with the receipt of the information indicating whether the signal can be compressively encoded or not, without performing special processing.

As described above, according to the third embodiment, the information receiving/recording/reproduction management unit is provided with the second recording medium 1208 that is randomly accessible at a speed higher than that of the first recording medium 1205, and the recording/re production management unit 1204 performs management so that compressively encoded data is initially recorded in the second recording medium 1208 and the compressively encoded data is recorded in the first recording medium 1205 after a decompressively decodable data structure is ensured in the second recording medium 1208. Therefore, even when the inputted analog video/audio signal cannot be compressively encoded, all compressively encoded data that is recorded in the first recording medium 1205 can securely have a decompressively decodable data structure. Further, from the foregoing, the data structure in the first recording medium 1205 is surely prevented from being broken at interrupt and resumption points of the recording. Consequently, when the compressively encoded data in the first recording medium 1205 is decompressively decoded to be reproduced, the disturbance in images or freeze of the system can be avoided more surely.

Also in the third embodiment, like in the second embodiment, the compressively uncodable signal detection unit 102 checks the horizontal components and the vertical components of the digital video data which is outputted from the A/D conversion unit 101, thereby deciding whether the inputted analog video/audio signal can be compressively encoded or not. However, the decision as to whether the inputted analog video/audio signal can be compressively encoded or not may be performed, as described in the first variation of the first embodiment, in the compressively uncodable signal detection unit 102 by checking the compressive encoding state in the compressively encoding unit 103, or may be performed, as described in the second variation of the first embodiment, in the compressively uncodable signal detection unit 102 by detecting a horizontal sync signal in the inputted analog video/audio signal and checking whether the horizontal sync signal is detected at given time intervals or not.

Embodiment 4.

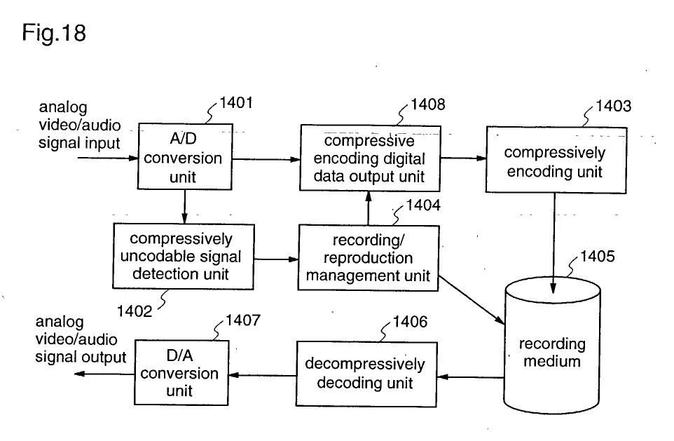

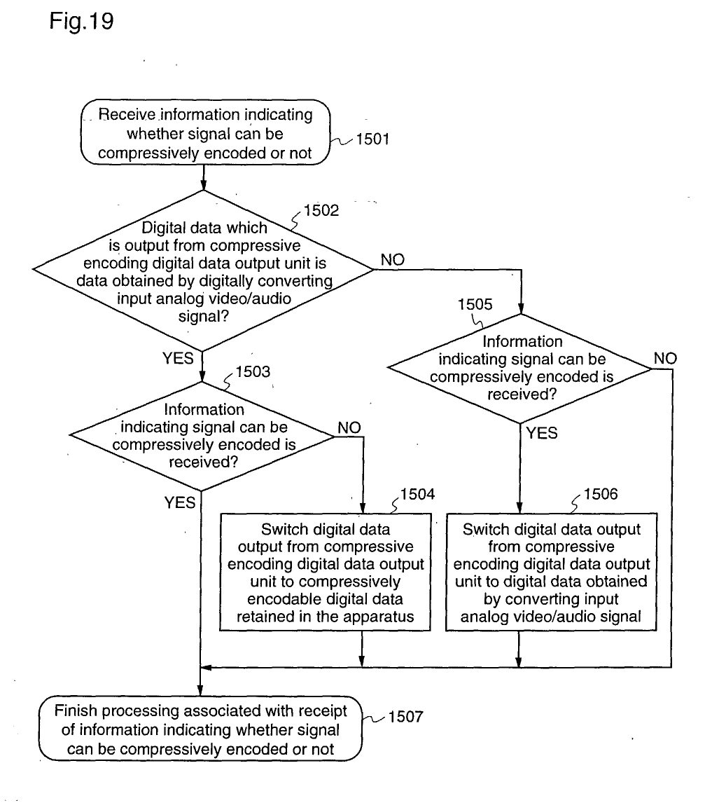

Hereinafter, a fourth embodiment of the present invention will be described with reference to FIGS. 18 and 19.

An information receiving/recording/reproduction apparatus according to the fourth embodiment further includes a compressively encoding digital data output unit for outputting digital data that is to be inputted to the compressively encoding unit, among the digital data that has been digitally converted by the A/D conversion unit. When the inputted analog video/audio signal can be compressively encoded on the basis of the information indicating whether the signal can be compressively encoded or not, which is outputted from the compressively uncodable signal detection unit, the inputted analog video/audio signal is converted into digital data and thereafter inputted to the compressively encoding unit. When the inputted analog video/audio signal cannot be compressively encoded, digital data that is held in the information receiving/recording/reproduction apparatus is inputted to the compressively encoding unit, in place of the digital data that cannot be compressively encoded. Accordingly, compressively encodable digital data is normally inputted to the compressively encoding unit.

Initially, with reference to FIG. 18, a structure of an information receiving/recording/reproduction apparatus according to the fourth embodiment will be described.

FIG. 18 is a block diagram illustrating the structure of the information receiving/recording/reproduction apparatus according to the fourth embodiment.

In this figure, the information receiving/recording/reproduction apparatus of the fourth embodiment comprises an A/D conversion unit 1401, a compressively uncodable signal detection unit 1402, a compressively encoding unit 1403, a recording/reproduction management unit 1404, a recording medium 1405, a decompressively decoding unit 1406, a D/A conversion unit 1407, and a compressive encoding digital data output unit 1408. The compressive encoding digital data output unit 1408 outputs digital data to the compressively encoding unit 1403 in accordance with the information indicating whether the signal can be compressively encoded or not, which is outputted from the recording/reproduction management unit 1404. Here, other elements are the same as those in the first embodiment, and accordingly their descriptions are omitted here.

Next, the operation of the information receiving/recording/reproduction apparatus according to the fourth embodiment having the aforementioned configuration, for recording an analog video/audio signal in the recording medium 1405 will be described.

The analog video/audio signal that is inputted to the information receiving/recording/reproduction apparatus is converted into digital data by the A/D conversion unit 1401, and outputted to the compressive encoding digital data output unit 1408. Simultaneously, horizontal components and vertical components of the digital video data outputted from the A/D conversion unit 1401 are checked in the compressively uncodable signal detection unit 1402. Then, it is decided whether an inputted analog video/audio signal can be compressively encoded or not, on the basis of the result of the checking, and information indicating whether the analog video/audio signal can be compressively encoded or not is outputted to the recording/reproduction management unit 1404.

At this time, when information indicating that the signal can be compressively encoded is given to the recording/reproduction management unit 1404 from the compressively uncodable signal detection unit 1402, a notification is given from the recording/reproduction management unit 1404 to the compressive encoding digital data output unit 1408 so that the inputted analog video/audio signal is converted into digital data, and then the digital data that has been obtained by digitally converting the inputted analog video/audio signal is inputted to the compressively encoding unit 1403.

When information indicating that the analog video/audio signal cannot be compressively encoded is given to the recording/reproduction management unit 1404 from the compressively uncodable signal detection unit 1402, a notification is given from the recording/reproduction management unit 1404 to the compressive encoding digital data output unit 1408 so that compressively encodable digital data which is retained in the information receiving/recording/reproduction apparatus is inputted to the compressively encoding unit 1403. Accordingly, the compressively encodable digital data which is retained in the apparatus is inputted from the compressive encoding digital data output unit 1408 to the compressively encoding unit 1403.

Then, the compressively encoding unit 1403 compressively encodes the inputted digital data, and the compressively encoded data are all recorded in the recording medium 1405.

The operation of the recording/reproduction management unit 1404 when the information indicating whether the inputted analog video/audio signal can be compressively encoded or not is given from the compressively uncodable signal detection unit 1402 will be described, with reference to a flowchart shown in FIG. 19.

FIG. 19 is a flowchart showing the operation of the recording/reproduction management unit according to the eighth embodiment when the information indicating whether the inputted analog video/audio signal can be compressively encoded or not is given thereto.

Initially, when the information indicating whether the analog video/audio signal can be compressively encoded or not, which is outputted from the compressively uncodable signal detection unit 1402, is received by the recording/reproduction management unit 1404 in step 1501, the kind of digital data that is now being outputted from the compressive encoding digital data output unit 1408 and the contents of the information indicating whether the signal can be compressively encoded or not, which is given to the recording/reproduction management unit 1404, are checked in steps 1502, 1503 and 1505.

When the digital data that is now being outputted from the compressive encoding digital data output unit 1408 is data that was obtained by digitally converting the inputted analog video/audio signal in step 1502, and information indicating that the signal can be compressively encoded is given in step 1503, the processing associated with the receipt of information indicating whether the signal can be compressively encoded or not is finished in step 1507, without performing special processing.

When the digital data that is now being outputted from the compressive encoding digital data output unit 1408 is data that was obtained by digitally converting the inputted analog video/audio signal in step 1502, and information indicating that the signal cannot be compressively encoded is given in step 1503, the operation proceeds to step 1504. In this step, the digital data that is outputted from the compressive encoding digital data output unit 1408 is changed to compressively encodable digital data that is retained in the information receiving/recording/reproduction apparatus. Thereafter, the processing associated with the receipt of the information indicating whether the signal can be compressively encoded or not is finished in step 1507.

When the digital data that is now being outputted from the compressive encoding digital data output unit 1408 is compressively encodable digital data that is retained in the information receiving/recording/reproduction apparatus in step 1502, and information indicating that the signal can be compressively encoded is given in step 1505, the digital data that is outputted from the compressive encoding digital data output unit 1408 is changed into data that was obtained by digitally converting the inputted analog video/audio signal, in step 1506. Then in step 1507, the processing associated with the receipt of the information indicating whether the signal can be compressively encoded or not is finished.

Further, when the digital data that is now outputted from the compressive encoding digital data output unit 1408 is compressively encodable digital data that is retained in the information receiving/recording/reproduction apparatus in step 1502, and information indicating that the signal cannot be compressively encoded is given in step 1505, the processing associated with the receipt of the information indicating whether the signal can be compressively encoded or not is finished in step 1507, without performing special processing.

Here, it is assumed that the compressively encodable digital data that is retained in the information receiving/recording/reproduction apparatus are data which constitute single-color image data, or data which constitute image data including message information. When the data which constitute single-color image data is employed as the compressively encodable digital data which is outputted from the compressive encoding digital data output unit 1408, the user checks directly the compressively encoded data that is recorded in the recording medium 1405 later, thereby to obtain the information indicating whether the signal can be compressively encoded or not. When the data which constitute image data including message information is employed as the compressively encodable digital data which is outputted from the compressive encoding digital data output unit 1408, an analog video/audio signal that is visually inputted can visually notify the user of the information indicating that the signal cannot be compressively encoded, when the data that is recorded in the recording medium 1405 is reproduced by the user.

As described above, the information receiving/recording/reproduction apparatus according to the fourth embodiment is further provided with the compressive encoding digital data output unit 1408 which receives digital data from the A/D conversion unit 1401, and always outputs compressively encodable digital data to the compressively encoding unit 1403 under control of the recording/reproduction management unit 1404, in accordance with the information indicating whether the signal can be compressively encoded or not, from the compressively uncodable signal detection unit 1402, thereby always inputting compressively encodable digital data to the compressively encoding unit 1403. Therefore, even when the inputted analog video/audio signal cannot be compressively encoded, the data structure in the recording medium 1405 can be prevented from being broken at the interrupt and resumption points of the recording. Consequently, the disturbance of images or freeze of the system can be avoided surely when the compressively encoded data in the recording medium 1405 is decompressively decoded to be reproduced.

Further, when the inputted analog video/audio signal cannot be compressively encoded, data which constitute single-color image data or data which constitute image data including message information are used as the compressively encodable digital data that are retained in the information receiving/recording/reproduction apparatus and outputted from the compressively encoding digital data output unit 1408. Therefore, the user can check whether the inputted analog video/audio signal is compressively encodable data or not.

Embodiment 5.

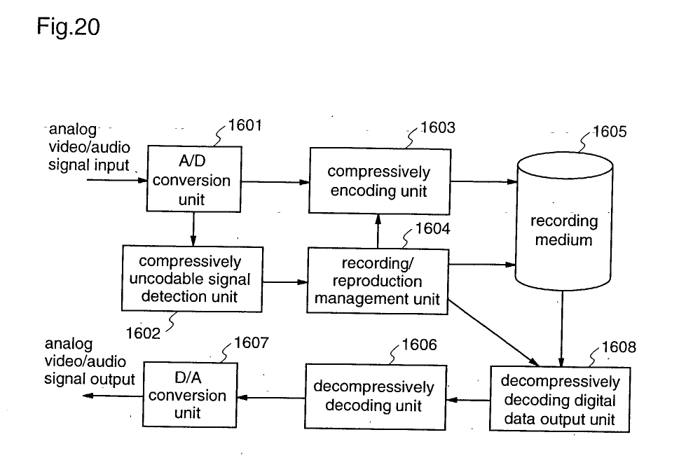

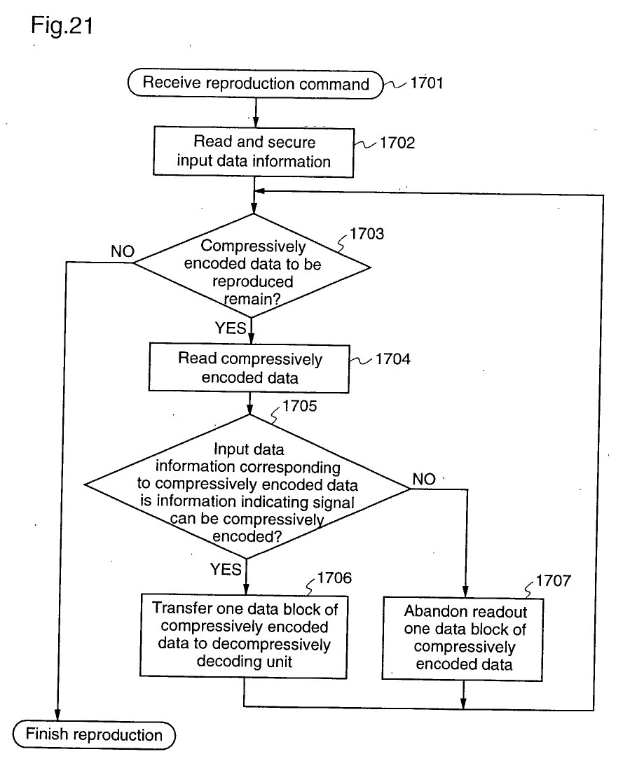

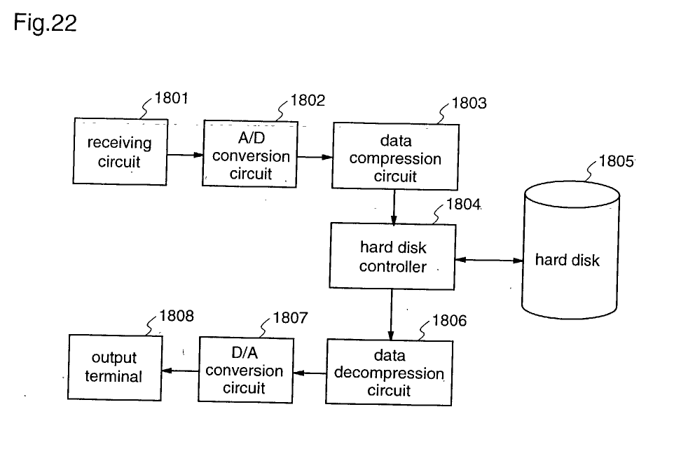

Hereinafter, a fifth embodiment of the present invention will be described with reference to FIGS. 20 and 21.

In an information receiving/recording/reproduction apparatus according to the fifth embodiment, the recording/reproduction management unit adds information indicating whether an inputted analog video/audio signal can be compressively encoded or not, which is given from the compressively uncodable signal detection unit, to compressively encoded data that is to be recorded in a recording medium in units of data structure (data blocks), and then records the data in the recording medium. When the compressively encoded data that is recorded in the recording medium is to be reproduced, the recording/reproduction management unit outputs the data block of the compressively encoded data to the decompressively decoding unit, in accordance with the information indicating whether the signal can be compressively encoded or not, being recorded together with the compressive coded data, when information indicating that the signal can be compressively encoded is added to the compressively encoded data. On the other hand, when information indicating that the signal cannot be compressively encoded is added to the compressively encoded data, the recording/reproduction management unit does not output the data block of the compressively encoded data to the decompressively decoding unit. Accordingly, decompressively decodable digital data can be always inputted to the decompressively decoding unit.

Initially, a structure of the information receiving/recording/reproduction apparatus according to the fifth embodiment will be described with reference to FIG. 20.

FIG. 20 is a block diagram illustrating the structure of the information receiving/recording/reproduction apparatus according to the fifth embodiment.

In this figure, the information receiving/recording/reproduction apparatus according to the first embodiment comprises an A/D conversion unit 1601, a compressively uncodable signal detection unit 1602, a compressively encoding unit 103, a recording/reproduction management unit 1604, a recording medium 1605, a decompressively decoding unit 1606, a D/A conversion unit 1607, and a decompressive decoding digital data output unit 16087. The recording/reproduction management unit 1604 receives information indicating whether an inputted analog video/audio signal can be compressively encoded or not, from the compressively uncodable signal detection unit 1602, and records the information indicating whether the signal can be compressively encoded or not in an area of the recording medium 1605, being different from an area in which the compressively encoded data is recorded, in data blocks of the compressively encoded data. The decompressive decoding digital data output unit 1608 outputs compressively encoded data obtained from the recording medium 1605, in accordance with the information from the recording/reproduction management unit 1604. Other elements are the same as those in the first embodiment, and their descriptions are omitted here.

Next, the operation of the information receiving/recording/reproduction apparatus according to the fifth embodiment having the above-mentioned configuration for recording an analog video/audio signal in the recording medium 1605 will be described.

The analog video/audio signal inputted to the information receiving/recording/reproduction apparatus is converted into digital data by the A/D conversion unit 1601, and outputted to the compressively encoding unit 1603. Simultaneously, horizontal components and vertical components of the digital video data that is outputted from the A/D conversion unit 1601 are checked by the compressively uncodable signal detection unit 1602. Then, it is decided whether the inputted analog video/audio signal can be compressively encoded or not on the basis of the result of the check, and information indicating whether the analog video/audio signal can be compressively encoded or not is outputted to the recording/reproduction management unit 1604.

When the information indicating that the signal can be compressively encoded or not (input data information) is outputted from the recording/reproduction management unit 1604 to the recording medium 1605, and the input data information is recorded in an area of the recording medium 1605, being different from an area in which compressively encoded data that is outputted from the compressively encoding unit 1603 is recorded adaptively to respective data blocks of the compressively encoded data. Here, the data block of the compressively encoded data corresponds to data in unit of one picture or one GOP.

When the compressively encoded data is reproduced from the recording medium 1605, the compressively encoded data and the input data information are initially read out from the recording medium 1605. When the input data information corresponding to the compressively encoded data is information indicating that the signal can be compressively encoded in the decompressive decoding digital data output unit 1608, one data block of compressively encoded data which has been outputted to the decompressive decoding digital data output unit 1608 is inputted to the decompressively decoding unit 1606. On the other hand, when the input data information corresponding to the compressively encoded data is information indicating that the signal cannot be compressively encoded in the decompressive decoding digital data output unit 1608, one data block of compressively encoded data that have been outputted is abandoned in the decompressive decoding digital data output unit 1608.

Then, the decompressively decoding unit 1606 carries out a process for decompressively decoding inputted compressively encoded data, and outputs the decompressively decoded data to the D/A conversion unit 1607. Then, the D/A conversion unit 1607 converts the inputted digital data into an analog video/audio signal and outputs the analog signal.

The operation of the recording/reproduction management unit 1604 when the compressively encoded data in the recording medium 1605 is to be reproduced will be described, with reference to a flowchart shown in FIG. 21.

FIG. 21 is a flowchart showing the operation of the recording/reproduction management unit according to the fifth embodiment when compressively encoded data is reproduced from the recording medium.

Initially, when a reproduction command is given to the recording/reproduction management unit 1604 in step 1701, the input data information that is information indicating whether the signal can be compressively encoded or not, corresponding to compressively encoded data to be reproduced, is read from the recording medium 1605 in step 1702. Then, it is checked whether the compressively encoded data to be reproduced remains in the recording medium 1605 or not in step 1703. When any compressively encoded data remains, the compressively encoded data is read from the recording medium 1605 and inputted to the decompressive decoding digital data output unit 1608 in step 1704. Then, the contents of the input data information corresponding to the compressively encoded data are checked in step 1705. When the input data information is information indicating that the signal can be compressively encoded, a command for outputting one data block of the compressively encoded data is given to the decompressively decoding digital data output unit 1608, thereby to output the compressively encoded data to the decompressively decoding unit 1606 in step 1706. On the other hand, when the input data information corresponding to the compressively encoded data is information indicating that the signal cannot be compressively encoded in step 1705, a command for abandoning one data block of the compressively encoded data is given to the decompressive decoding digital data output unit 1608 in step 1707, whereby one data block of the compressively encoded data is abandoned by the decompressively decoding digital data output unit 1608.

The above-mentioned processes after step 1703, i.e., processes after the check as to whether compressively encoded data to be reproduced remains in the recording medium 1605 or not are repeated until no compressively encoded data to be reproduced remain in the recording medium 1605, thereby reproducing compressively encoded data that is recorded in the recording medium 1605.

As described above, according to the fifth embodiment, when compressively encoded data is to be recorded in the recording medium 1605, input information data that is information indicating whether the signal can be compressively encoded or not, corresponding to the compressively encoded data in units of data block, is recorded together with the compressively encoded data by the recording/reproduction management unit 1604. Then, when the compressively encoded data is to be reproduced, under the management of the recording/reproduction management unit 1604, a data block including the compressively encoded data is abandoned when the input information data indicates that the signal cannot be compressively encoded in the decompressive decoding digital data output unit 1608, whereby decompressively decodable digital data are always inputted to the decompressively decoding unit 1606. Therefore, even when the inputted analog video/audio signal cannot be compressively encoded, the data structure in the recording medium 1605 is prevented from being broken at the interrupt and resumption points of the recording, whereby the disturbance of images and freeze of the system can be avoided when the compressively encoded data in the recording medium 1605 is decompressively decoded to be reproduced.

### INDUSTRIAL AVAILABILITY

The information receiving/recording/reproduction method and the information receiving/recording/reproduction apparatus according to the present invention are quite useful in preventing disturbance of images or freeze of the system, when converting an inputted analog video/audio signal into digital data, compressively encoding the digital data to be recorded, then decompressively decoding the recorded data, converting the decompressively decoded data into analog data, and thereafter reproducing the analog data.

1. An information receiving/recording/reproduction apparatus which includes an A/D conversion means for converting an inputted analog video/audio signal into digital data; a compressively encoding means for compressively encoding the digital data; a recording/reproduction management means for managing a state where the compressively encoded digital data are recorded or reproduced in or from a first recording medium that is randomly accessible; a decompressively decoding means for decompressively decoding the compressively encoded digital data; and a D/A conversion means for converting the digital data into an analog video signal, wherein
a compressively uncodable signal detection means is further included for detecting information indicating whether the inputted analog video/audio signal can be compressively encoded or not, and
the recording/reproduction management means manages the state where the compressively encoded digital data are recorded or reproduced into or from the first recording medium in accordance with the information that is obtained by the compressively uncodable signal detection means.

2. The information receiving/recording/reproduction apparatus of claim 1 wherein
the compressively encoding means or the decompressively decoding means compressively encodes or decompressively decodes the data according to MPEG (Moving Picture Experts Group) standards.

3. The information receiving/recording/reproduction apparatus of claim 1 wherein
the compressively uncodable signal detection means: detects the number of data corresponding to horizontal one line and the number of lines corresponding to vertical one field, of the digital video data that is obtained by the A/D conversion means;
compares the detected number of data with a prescribed number of data per line corresponding to the analog video/audio signal, and the detected number of lines with a prescribed number of lines per field corresponding to the analog video/audio signal; and
outputs information whether the inputted analog video/audio signal can be compressively encoded or not on the basis of obtained comparison results.

4. The information receiving/recording/reproduction apparatus of claim 1 wherein
the compressively uncodable signal detection means receives information indicating whether a state of compressively encoding for the digital data in the compressively encoding means is successful or unsuccessful, and outputs the information indicating whether the inputted analog video/audio signal can be compressively encoded or not in accordance with the received information.

5. The information receiving/recording/reproduction apparatus of claim 1 wherein
the compressively uncodable signal detection means detects a horizontal sync signal in the inputted analog video/audio signal, decides whether the horizontal sync signal is detected at given time intervals, and outputs the information indicating whether the inputted analog video/audio signal can be compressively encoded or not, on the basis of an obtained result of the decision.

6. The information receiving/recording/reproduction apparatus of claims 1, 4, and 5 wherein
the recording/reproduction management means further includes a data management means for managing the compressively encoded digital data to ensure a decompressively decodable data structure in the first recording medium.

7. The information receiving/recording/reproduction apparatus of claim 6 wherein
the data management means records the compressively encoded digital data in the first recording medium, with ensuring a data structure in units of one picture.

8. The information receiving/recording/reproduction apparatus of claim 6 wherein
the data management means records the compressively encoded digital data in the first recording medium, with ensuring a data structure in units of one GOP (Group of Picture) according to a format based on MPEG standards.

9. The information receiving/recording/reproduction apparatus of claim 7 wherein
when it is informed that the inputted analog video/audio signal cannot be compressively encoded while the compressively encoded digital data is being recorded in the first recording medium, the data management means deletes data up to a boundary part of one picture which has already recorded in the first recording medium, to ensure the data structure in units of one picture.

10. The information receiving/recording/reproduction apparatus of claim 8 wherein
when it is informed that the inputted analog video/audio signal cannot be compressively encoded while the compressively encoded digital data is being recorded in the first recording medium, the data management means deletes data up to a boundary part of one GOP that has been already recorded in the first recording medium, to ensure the data structure in units of one GOP.

11. The information receiving/recording/reproduction apparatus of claims 1, 4 and 5 wherein
a second recording medium which is randomly accessible at a speed higher than that of the first recording medium is further included, and
the recording/reproduction management means further includes a data management means for temporarily storing the compressively encoded digital data in the second recording medium, and thereafter recording the data that is stored in the second recording medium into the first recording medium.

12. The information receiving/recording/reproduction apparatus of claim 11 wherein
the data management means records the compressively encoded digital data in the second recording medium with ensuring a data structure in units of one picture, and records the data which securely has the data structure in units of one picture in the second recording medium, into the first recording medium.

13. The information receiving/recording/reproduction apparatus of claim 11 wherein
the data management means records the compressively encoded digital data in the second recording medium with ensuring a data structure in units of one GOP according to a format based on MPEG standards, and records the data which securely has the data structure in units of one GOP in the second recording medium, into the first recording medium.

14. The information receiving/recording/reproduction apparatus of claim 12 wherein
when it is informed that the inputted analog video/audio signal cannot be compressively encoded while the compressively encoded digital data is being recorded in the second recording medium, the data management means deletes data up to a boundary part of one picture that has already been recorded in the second recording medium, to ensure the data structure in units of one picture.

15. The information receiving/recording/reproduction apparatus of claim 13 wherein
when it is informed that the inputted analog video/audio signal cannot be compressively encoded while the compressively encoded digital data is being recorded in the second recording medium, the data management means deletes data up to a boundary part of one GOP that has already been recorded in the second recording medium, to ensure the data structure in units of one GOP.

16. The information receiving/recording/reproduction apparatus of claim 1 wherein
a compressive encoding digital data output means is further included for always outputting digital data that can be compressively encoded, and
the compressively encoding digital data output means: outputs the digital data that is obtained by converting the inputted analog video/audio signal into a digital format when it is informed by the compressively uncodable signal detection means that the inputted analog video/audio signal can be compressively encoded; and
outputs digital data that is retained in the information receiving/recording/reproduction apparatus when it is informed by the compressively uncodable signal detection means that the inputted analog video/audio signal cannot be compressively encoded.

17. The information receiving/recording/reproduction apparatus of claim 16 wherein
the digital data which are retained in the information receiving/recording/reproduction apparatus and outputted by the compressive encoding digital data output means are data which constitute single-color image data.

18. The information receiving/recording/reproduction apparatus of claim 16 wherein
the digital data which are retained in the information receiving/recording/reproduction apparatus and outputted by the compressive encoding digital data output means are data which constitute image data including message information.

19. The information receiving/recording/reproduction apparatus of claim 1 wherein
the recording/reproduction management means further includes:
an input data information recording means for recording compressively encoded digital data in the first recording medium in arbitrary units, and adding the information that is obtained from the compressively uncodable signal detection means to the compressively encoded digital data that has been recorded in the first recording medium in the arbitrary units, to record the same,
said information receiving/recording/reproduction apparatus further including:
a decompressive decoding digital data output means for selecting data that is to be outputted to the decompressively decoding means among the compressively encoded digital data that is read from the first recording medium, in accordance with the information that has been recorded in the first recording medium by the input data information recording means, and outputting the selected data.

20. The information receiving/recording/reproduction apparatus of claim 19 wherein
the decompressive decoding digital data output means: detects the information that has been recorded by the input data information recording means, from the data read from the first recording medium;
decompressively decodes the readout data when the detected information indicates that the inputted analog video/audio signal can be compressively encoded; and
abandons the readout data when the detected information indicates that the inputted analog video/audio signal cannot be compressively encoded.

21. The information receiving/recording/reproduction apparatus of claim 19 wherein
the recording/reproduction management means records the compressively encoded digital data in the first recording medium in units of one picture.

22. The information receiving/recording/reproduction apparatus of claim 19 wherein
the recording/reproduction management means records the compressively encoded digital data in the first recording medium in units of one GOP according to a format based on MPEG standards.

23. An information receiving/recording/reproduction method for converting an inputted analog video/audio signal into digital data, compressively encoding the digital data, recording the compressively encoded digital data in a first recording medium that is randomly accessible, decompressively decoding the compressively encoded digital data that is read from the first recording medium, converting the digital data into an analog video signal, and outputting the analog video signal, comprising:
a compressively uncodable signal detection step of detecting information indicating whether the inputted analog video/audio signal can be compressively encoded or not; and
a recording/reproduction management step of managing a state where the compressively encoded digital data are recorded or reproduced, in accordance with the information that is obtained in the compressively uncodable signal detection step.

24. The information receiving/recording/reproduction method of claim 23 wherein
the digital data is compressively encoded or decompressively decoded according to MPEG (Moving Picture Experts Group) standards.

25. The information receiving/recording/reproduction method of claim 23 wherein
in the compressively uncodable signal detection step, when the inputted analog video/audio signal is converted into digital data, the number of data corresponding to horizontal one line and the number of lines corresponding to a vertical one field, of the obtained digital video data are detected;
the detected number of data is compared with a prescribed number of data per line corresponding to the analog video/audio signal, and the detected number of lines is compared with a prescribed number of lines per field corresponding to the analog video/audio signal; and
information indicating whether the inputted analog video/audio signal can be compressively encoded or not is outputted on the basis of obtained comparison results.

26. The information receiving/recording/reproduction method of claim 23 wherein
in the compressively uncodable signal detection step, when the digital data is compressively encoded, information indicating whether a state of the compressive encoding is successful or unsuccessful is received, and information indicating whether the inputted analog video/audio signal can be compressively encoded or not is outputted in accordance with the received information.

27. The information receiving/recording/reproduction method of claim 23 wherein
in the compressively uncodable signal detection step, a horizontal sync signal in the inputted analog video/audio signal is detected, it is decided whether the horizontal sync signal is detected at given time intervals, and information indicating whether the inputted analog video/audio signal can be compressively encoded or not is outputted on the basis of an obtained result of the decision.

28. The information receiving/recording/reproduction method of one of claims 23, 26 and 27, wherein
the recording/reproduction management step further includes a data management step of managing the compressively encoded digital data that is recorded in the first recording medium to ensure a decompressively decodable data structure.

29. The information receiving/recording/reproduction method of claim 28 wherein
in the data management step, the compressively encoded digital data is recorded in the first recording medium, with ensuring a data structure in units of one picture.

30. The information receiving/recording/reproduction method of claim 28 wherein
in the data management step, the compressively encoded digital data is recorded in the first recording medium, with ensuring a data structure in units of one GOP (Group of Picture) according to a format based on MPEG standards.

31. The information receiving/recording/reproduction method of claim 29 wherein
in the data management step, when it is informed that the inputted analog video/audio signal cannot be compressively encoded while the compressively encoded digital data is being recorded in the first recording medium, data are deleted up to a boundary part of one picture which has been already recorded in the first recording medium, to ensure the data structure in units of one picture.

32. The information receiving/recording/reproduction method of claim 30 wherein
in the data management step, when it is informed that the inputted analog video/audio signal cannot be compressively encoded while the compressively encoded digital data is being recorded in the first recording medium, data are deleted up to a boundary part of one GOP which has already been recorded in the first recording medium, to ensure the data structure in units of one GOP.

33. The information receiving/recording/reproduction method of any of claims 23, 26 and 27 wherein
a second recording medium which is randomly accessible at a speed higher than that of the first recording medium is further included, and
the recording/reproduction management step further includes a data management step of temporarily storing the compressively encoded digital data in the second recording medium, and thereafter recording the data stored in the second recording medium into the first recording medium.

34. The information receiving/recording/reproduction method of claim 33 wherein
in the data management step, the compressively encoded digital data is recorded in the second recording medium with ensuring a data structure in unit of one picture, and the data which securely has the data structure in unit of one picture in the second recording medium is recorded in the first recording medium.

35. The information receiving/recording/reproduction method of claim 33 wherein
in the data management step, the compressively encoded digital data is recorded in the second recording medium with ensuring a data structure in unit of one GOP according to a format based on MPEG standards, and the data which securely has the data structure in unit of one GOP in the second recording medium is recorded in the first recording medium.

36. The information receiving/recording/reproduction method of claim 34 wherein
in the data management step, when it is informed that the inputted analog video/audio signal cannot be compressively encoded while the compressively encoded digital data is being recorded in the second recording medium, data are deleted up to a boundary part of one picture that has already been recorded in the second recording medium, to ensure the data structure in unit of one picture.

37. The information receiving/recording/reproduction method of claim 35 wherein
in the data management step, when it is informed that the inputted analog video/audio signal cannot be compressively encoded while the compressively encoded digital data is being recorded in the second recording medium, data are deleted up to a boundary part of one GOP which has already been recorded in the second recording medium, to ensure the data structure in unit of one GOP.

38. The information receiving/recording/reproduction method of claim 23 wherein
a compressively encoding digital data output step of always outputting digital data that can be compressively encoded is further included, and
in the compressively encoding digital data output step,
when it is informed that the inputted analog video/audio signal can be compressively encoded, digital data that is obtained by converting the inputted analog video/audio signal into a digital format is outputted, and
when it is informed that the inputted analog video/audio signal cannot be compressively encoded, digital data that is retained in an information receiving/recording/reproduction apparatus is outputted.

39. The information receiving/recording/reproduction method of claim 38 wherein
the digital data which are retained in the information receiving/recording/reproduction apparatus and outputted in the compressively encoding digital data output step are data which constitute single-color image data.

40. The information receiving/recording/reproduction method of claim 38 wherein
the digital data which are retained in the information receiving/recording/reproduction apparatus and outputted in the compressively encoding digital data output step are data which constitute image data including message information.

41. The information receiving/recording/reproduction method of claim 23 wherein
the recording/reproduction management step further includes:
an inputted data information recording step of recording compressively encoded digital data in the first recording medium in arbitrary units, and adding the information that is obtained in the compressively uncodable signal detection step to the compressively encoded digital data that has been recorded in the first recording medium in the arbitrary units, to record the same,
said information receiving/recording/reproduction method further including:
a decompressive decoding digital data output step of selecting data that is to be decompressively decoded among the compressively encoded digital data that is read from the first recording medium, in accordance with the information that has been recorded in the first recording medium in the input data information recording step, and outputting the selected data.

42. The information receiving/recording/reproduction method of claim 41 wherein
in the decompressive decoding digital data output step, the information that has been recorded in the input data information recording step is detected from the data read from the first recording medium,
the readout data is decompressively decoded when information indicating that the inputted analog video/audio signal can be compressively encoded is detected, and
the readout data is abandoned when information indicating that the inputted analog video/audio signal cannot be compressively encoded is detected.

43. The information receiving/recording/reproduction method of claim 41 wherein
in the recording/reproduction management step, compressively encoded digital data is recorded in the first recording medium in unit of one picture.

44. The information receiving/recording/reproduction method of claim 41 wherein
in the recording/reproduction management step, compressively encoded digital data is recorded in the first recording medium in unit of one GOP according to a format based on MPEG standard.
